(19) United States
(12) Patent Application Publication
(10) Pub. No.: US 2023/0018041 A1
(43) Pub. Date: Jan. 19, 2023

(54) OPTICAL ANALYSIS PAIRED PLOT AUTOMATED FERTIGATION SYSTEMS, METHODS AND DATASTRUCTURES

(71) Applicant: NUtech Ventures, Lincoln, NE (US)

(72) Inventors: Joe Luck, Raymond, NE (US); Jackson Stansell, Lincoln, NE (US); Brian Krienke, Lincoln, NE (US); Tyler Smith, Lincoln, NE (US); Samantha Teten, Lincoln, NE (US); Daran Rudnick, Lincoln, NE (US)

(21) Appl. No.: 17/589,289

(22) Filed: Jan. 31, 2022

Related U.S. Application Data
(60) Provisional application No. 63/147,497, filed on Feb. 9, 2021.

(51) Int. Cl. G06Q 10/06; G06Q 50/02

(52) U.S. Cl. CPC G06Q 10/06393; G06Q 50/02

(57) ABSTRACT

Automated fertigation systems and methods determine crop N status from a vegetation index calculated from acquired image data of indicator blocks having at least two plots, one with a reduced N application rate (canary) and one with an increased N application rate (reference) versus a bulk area N application rate. In a preferred method, sub-regions are defined in a field being managed. In each sub-region, N (nitrogen) is applied to create adjacent canary and reference plots, wherein a canary plot is given less than a designated N amount and a reference plot. The sub-regions are subsequently imaged. A fertigation decision is made for each sub-region based upon automatic analysis of the vegetation indices of the canary and reference plots in each sub-region.

### PRIORITY CLAIM AND REFERENCE TO RELATED APPLICATION

The application claims priority under 35 U.S.C. § 119 and all applicable statutes and treaties from prior U.S. provisional application Ser. No. 63/147,497 which was filed Feb. 9, 2021, which application is incorporated by reference herein.

### FIELD

Fields of the invention included fertigation systems, controllers and software for such systems, and optical analysis.

### BACKGROUND

Application of nitrogen (N) fertilizer is important for ensuring that crops receive sufficient nitrogen throughout the growing season. Excessive application of N fertilizers can lead to significant N losses from the crop production system through gaseous emissions, surface runoff, and nitrate leaching. These N losses are associated with negative environmental impacts such as increased atmospheric greenhouse gas (GHG) concentrations, hypoxic hyper-eutrophic zones in surface water bodies, and groundwater contamination. Increasing N use efficiency (NUE) in irrigated corn cropping systems can increase crop yield, reduce costs and alleviate such ancillary problems from N application to crops. Since fertilizer is the largest single operating cost in corn production (nearly 40%) and nitrogen fertilizer is the most expensive and most applied, improvements in NUE are financially advantageous for producers.

Currently implemented N management strategies do not maximize NUE. Typical strategies apply the majority of the total applied N before planting, which is asynchronous with the maximal N uptake period for many N intensive crops such as corn. Split nitrogen application strategies involving in-season application of a substantial portion of total applied N have been shown to be effective for improving NUE in grain production, likely because in-season applications are more synchronous with crop N uptake. In-season nitrogen applications alone, however, are not enough to maximize NUE. When in-season N applications are made at a uniform rate and are improperly timed, over- or under-applications of nitrogen can occur due to spatio-temporal variation in optimal N rate (ONR) within a single field.

Precision N application approaches have been proposed to spatially and temporally optimize N application for increased NUE. One promising type of approach is a responsive approach.

The responsive approach uses crop canopy reflectance measurements collected by remote or proximal sensors during the growing season to inform in-season N management decisions. Responsive N strategies have demonstrated the ability to improve NUE when implemented using both active sensors mounted on the boom of a high-clearance applicator to inform N application rate in real-time and hand-held chlorophyll meters to inform yes/no fertigation decisions. See, e.g., Blackmer, T. M., Schepers, J. S. (1995), “Use of a Chlorophyll Meter to Monitor Nitrogen Status and Schedule Fertigation for Corn,” Journal of Production Agriculture, 8(1). https://naldc.nal.usda.gov/download/16751/PDF; Scharf, P. C., Shannon, D. K., Palm, H. L., Sudduth, K. A., Drummond, S. T., Kitchen, N. R., . . . Oliveira, L. F. (2011), “Sensor-based nitrogen applications out-performed producer-chosen rates for corn in on-farm demonstrations,” Agronomy Journal, 103(6), 1683-1691. https://doi.org/10.2134/agronj2011.0164; Thompson, L. J., et al. (2015), “Model and Sensor-Based Recommendation Approaches for In-Season Nitrogen Management in Corn,” Agronomy & Horticulture—Faculty Publications, 107(6). https://doi.org/10.2134/argonj15.0116.

Blackmer and Schepers (1995) researched a quantitative method for determining fertigation application timing in irrigated corn production systems using SPAD 502 hand-held chlorophyll meter measurements. SPAD 502 hand-held chlorophyll meters measure reflectance in the red (R) and near infrared (NIR) bands to calculate the SPAD meter value. Each week from the V6 to the R5 growth stage, 30 randomly selected plants were measured in each bulk treatment area. A sufficiency index (SI) was then calculated by taking the ratio of the sample measurements to the chlorophyll meter measurements from a high-N reference field sub-region. If the SI in a bulk treatment area remained <0.95 for two consecutive weeks, then the treatment area was fertigated at a rate of 30 lb N/ac. The rate was not adjusted based on the SI value. There were no significant yield differences between the high-N reference field sub-regions and the fertigation treatments which received less N over the course of the growing season, which would correspond to a higher partial factor of productivity (lb grain per lb N) for the fertigation treatments, through the value was not reported.

Other research has attempted to implement sensor-based fertigation in spring wheat and cotton production. See, King, B. A., et al. (1996) “Spatially Varied Nitrogen Application Through a Center Pivot Irrigation System,” Precision Agriculture. https://doi.org/10.2134/1996.precisionagproc3.c9; Williams, P. (2018). Development of a Sensor-Based, Variable-Rate Fertigation Technique for Overhead Irrigation Systems. All Dissertations, 2176. Retrieved from https://tigerprints.clemson.edu/cgi/viewcontent.cgi?article=3179&content=all_dissertations. King et al. (1996) used the NDVI (normalized difference vegetation index) collected from a spring wheat crop canopy to determine a field's relative yield potential zones and create a N fertigation prescription in conjunction with a producer's yield goal and university fertilizer recommendations for that yield goal. Impact on yield and N were not reported. Williams (2018) demonstrated that variable rate N prescriptions informed by in-season NDVI measurements of cotton could be implemented with variable rate fertigation equipment on a linear move irrigation system to nearly double NUE.

Most prior responsive N strategies have been implemented using high-clearance applicators, which limit the application window and minimize application frequency potential due to conflicts with crop growth stage, field conditions, and labor.

Fertigation is the practice of applying fertilizer through an irrigation system. Fertigation provides advantages compared to high-clearance applicators. The advantages include immediate incorporation of fertilizer, reduced soil compaction from excessive field passes by heavy machinery, and reduced labor time and expenses. Fertigation also maximizes the value of the capital invested in an irrigation system, improves application timeliness, and readily provides multiple application opportunities throughout the growing season. See, e.g. Lo, T. H et al., (2019) “Variable-Rate Chemigation via Center Pivots. Journal of Irrigation and Drainage Engineering, 145(7). Verbree, D., McClure, A. T., Leib, B. (2013), “Fertigation of Row-crops Using Overhead Irrigation,” https://extension.tennessee.edu/pulications/Documents/W303.pdf; Williams, P. (2018) “Development of a Sensor-Based, Variable-Rate Fertigation Technique for Overhead Irrigation Systems,” All Dissertations, 2176. https://tigerprints.clemson.edu/cgi/viewcontent.cgi?article=3179&context=all_dissertations. These advantages are particularly true for center pivot irrigation systems, which are the dominant form of irrigation system used for open field production in the United States.

Kaprielian U.S. Pat. No. 7,937,187 describes a computer-controlled irrigation and fertigation system. The system is directed to plants grown in a container, such as elevated berm. In such a closed system the water and nutrients are simple to measure, and the disclosed system determines the amount of nutrients and water and delivers nutrients and water responsively according to a predetermined schedule. The sensors are under the plant containers and measure the total amount of water available to a plant in the container. This system has no application to traditional field-based agriculture.

Ozawa et al. U.S. Pat. No. 10,561,081 describes a fertigation system for crop cultivation. This system is generally applicable to small land areas, such as typical farms in Japan. The system uses in-ground soil electrical conductivity sensors, humidity sensors and/or solar radiation sensors. The expense and number of sensors required for automated control makes this system impractical for large land areas. In addition, the various quantities measured are not direct measures of how plants have taken up nitrogen but are instead measure nitrogen concentration in the soil.

U.S. Pat. No. 9,652,840 describes a system for remote nitrogen monitoring and prescription. Images of a geographic region are obtained at two different times. The images are obtained, for example, through satellite imagery. Nitrogen status anomalies are determined using reflectance data and crop nitrogen status is determined using a combination of reflectance data and nitrogen change models. A threshold is used to trigger a nitrogen prescription. The threshold can be determined based upon comparisons with historic reflectance values, e.g., identifying a nitrogen stress in response to a reflectance value for a current instance of a recurrent time point exceeding an expected reflectance. Each region or zone is given a prescription based upon its historical or expected performance. For example, a set of historic remote images of the management region (e.g., 5 or more years of satellite images) is processed into a potential yield value for each analysis zone, and this yield value is used in conjunction with model-estimated N availability for the rest of the growing season to determine the appropriate amount of N to apply. This type of remote imaging over an extended time period is primarily useful for setting initial nitrogen prescriptions for a given region. The standard imagery analysis used and reliance on estimates involving historic data are not well suited to specifically distinguish N stress from other stress during the growing season or to make real-time application decisions at any point during the growing season adjusted within portions of a region, e.g., an irrigation zone of an individual plot, to improve and equalize NUE in all portions of a given region, e.g. an irrigation region served by a center pivot irrigation system.

Ghadge et al., “Fertigation System to Conserve Water and Fertilizers Using Wireless Sensing Network,” International Journal of Engineering Research in Computer Science and Engineering, Vol 5, Issue 3, March 2018 describes a system that uses soil moisture sensors and soil pH sensors to improve fertigation. The paper describes testing on citrus trees. This system requires sensors to be installed near plants, which is expensive and inconvenient for large crops. In-ground sensors can also have reliability problems due to ground conditions.

Thompson and Puntel, “Transforming Unmanned Aerial Vehicle (UAV) and Multispectral Sensor into a Practical Decision Support System for Precision Nitrogen Management in Corn,” Remote Sens. Vol. 12, p. 1597, (May 17, 2020) describes the use of unmanned aerial vehicles to take multispectral images of crops and classify nitrogen status of crops to prescribe a singular nitrogen application made as a sidedress (during the growing season) application and uses the Holland-Schepers algorithm to compute a prescription for spatially variable nitrogen application rates at each point in the field. Human intervention is required to process imagery and obtain fertilizer application decisions. The algorithm also requires a clustering-based approach to filter soil pixels from images prior to use. This is slow and challenging to abstract to a variety of site conditions, and typically requires human supervision to implement.

### SUMMARY OF THE INVENTION

Preferred automated fertigation systems and methods determine crop N status from a vegetation index calculated from acquired image data of indicator blocks having at least two plots, one with a reduced N application rate (canary) and one with an increased N application rate (reference) versus a bulk area N application rate. In a preferred method, sub-regions are defined in a field being managed. In each sub-region, N (nitrogen) is applied to create adjacent canary and reference plots, wherein a canary plot is given less than a designated N amount and a reference plot. The sub-regions are subsequently imaged. A fertigation decision is made for each sub-region based upon automatic analysis of the vegetation indices of the canary and reference plots in each sub-region

### BRIEF DESCRIPTION OF THE DRAWINGS

FIG. 1 is a block diagram showing important modules of preferred fertigation systems, methods and data structures;

FIG. 2 is a flow diagram illustrated a preferred fertigation method that was demonstrated experimentally;

FIG. 3 is a block diagram of an example preferred fertigation system of the invention for center pivot irrigation;

FIG. 4 is a diagram the preferred prototype program modules and the flow of the module operation;

FIG. 5 shows an example exported output from the FIG. 4 modules in a spreadsheet format for indicator block analyses;

FIG. 6 shows an example exported output from the FIG. 4 modules in a ESRI shapefile format;

FIG. 7 shows decision tree logic for reaching a fertigation decision based upon the image analysis in a preferred system and method;

FIG. 8 shows an example prescription output to a spreadsheet for review or storage;

FIG. 9 shows an example formatted table for a user interface for a fertigation system of the invention;

FIG. 10A illustrates initial N treatments to establish indicator blocks that can be used as initial data for fertigation methods of the invention;

FIG. 10B model of system processing speed (total runtime) given imagery resolution (pixels) and field configuration characteristics (total regions of interest) for a UAV collected imager;

FIG. 10C a model of total runtime for satellite collected images;

FIG. 11 is a data table showing that the invention produces comparable yields compared to prior fertigation methods despite using substantially less total N application;

FIG. 12 shows a scatter plot of the differences in nitrogen use efficiency (measured as PFP) and marginal net return between the sensor-based fertigation management approaches and standard grower management on a site-by-site basis;

FIGS. 13A and 13B show average differences between sensor-based fertigation management approaches and typical grower management across test sites;

FIG. 14 is a flowchart illustrating the function of a preferred module for image preprocessing;

FIG. 15 is a flowchart illustrating the function of a preferred module for image analysis;

FIG. 16 is an example user interface screen showing a result of fertigation image analysis; and

FIG. 17 is example user interface screen showing a result of fertigation decision analysis;

FIG. 18 shows the logic of a preferred helper module to speed the image analytics module;

FIG. 19 is another module that can be used for fertigation decision of module of FIG. 4; and

FIG. 20 shows logic for a preferred prescription generation module of FIG. 4.

### DETAILED DESCRIPTION OF THE PREFERRED EMBODIMENTS

Preferred fertigation systems, methods and data structures use in-season multispectral imagery comparing irrigation regions to quantify field spatial variability, crop performance and/or nitrogen sufficiency and provide automated high-frequency, binary fertigation decisions and associated prescriptions throughout the growing season. Data obtained can be retained and used to build data structures stored on a non-volatile medium. Preferred data structures include a training data set for an artificial intelligence engine that can then alter and improve automated high-frequency, fertigation decisions. Preferred data structures further include organization and data useful for field financial analysis and insurance analysis. A preferred system includes a center pivot irrigation system with a chemigation injection pump for which operations are informed by a controller that uses the in-season multi-spectral imagery to determine and alter nitrogen applications with a predetermined or variable number of irrigation events.

Preferred systems and methods enable commercial-scale automated implementation of image analytics, fertigation decisions, and prescription generation processes through controllers and control software useful for crop advisors, growers, researchers, and others to use. Preferred systems can, for example: 1) Reduce processing time from image input to prescription export, including facilitated user interaction time, to under 10 minutes per 160-acre field; 2) Utilize field specific geospatial information, irrigation system characteristics, and fertilizer injection pump parameters to analyze images, generate fertigation decisions, and compose prescriptions without repetitive user input; 3) Remove non-vegetative features from input images; 4) Analyze input images to produce accurate quantitative metrics and generate appropriate fertigation decisions according to the sensor-based fertigation management protocol; 5) Generate prescriptions in a transferable file format containing information organized to meet the compatibility criteria of commercially available rate control systems; and 6) Export important operational information, such as total gallons of fertilizer required for the application, total time of the application, product needed, and movement, e.g., pivot speed or coverage rate which provides speed and area covered simultaneously.

A preferred sensor-based fertigation management method uses high-throughput multispectral imagery availability and present analyses to make automated fertigation systems, and a prototype has been demonstrated for commercial-scale implementation in center pivot irrigated corn production. Methods can automatically inform fertigation applications that are used with or are part of fertigation systems. Preferred embodiments provide a tool that generates fertigation decisions and prescriptions that can be displayed and accepted via an interface by a user of a fertigation system, and the display can include instructions necessary to automate the fertigation operations.

Experiments with the prototype showed improvement in NUE for sensor-based management in 94% of implementations, with increases in profit observed in at least 59% of implementations. While demonstrated as being effective for corn, the preferred methods and systems are expected to be effective for other commonly fertigated row crops, for example cotton, potatoes, and wheat. NDRE is applicable to cotton, NDVI, SCCCI (simplified canopy chlorophyll content index), and CIRE (chrolorphyll index using red edge) may also be used. NDRE is also applicable in wheat, but NDVI is commonly used. Modeling of prototype system performance using remotely stored images based on collected execution data exhibited that the software can process 12 cm/pixel resolution UAV imagery from image import to prescription generation for a typical quarter section in 7 minutes, including user interaction time. Satellite imagery at 3 m/pixel resolution for the same typical quarter section could be processed in approximately 3 minutes.

Preferred systems are implemented as software installed in a fertigation system controller. Additional embodiments include software stored on a fixed medium, such as a personal computer (desktop or laptop) with local storage or cloud-based storage. Images can be pulled into the system on the computer and outputs of the system can be exported, such as on a data storage device or via a communications link, to provide settings to a fertigation system or for upload to a web interface for the commercially available fertigation system controller. Additional embodiments provide a web application for optimal usability, with the fertigation controller accessing the web application via user interface controls. Preferred methods and systems include automated logging of applied fertilizer through as-applied fertigation data post-processing and automated identification of optimal management regions based on management zones. This builds a valuable data structure, which can be used, for example, as a training data set for an artificial intelligence system. With a web interface, an artificial intelligence engine can provide fertigation decisions after being trained on a data structure of the invention and then, during operation, receiving a new data set of images for an area covered by a fertigation system. Additional embodiments provide a fertigation controller that is connected to the web via cellular and has no user interface controls. User interface controls for the controller are all hosted on a web application. Additional embodiments of the system have a web application that would interface with the controller's web-based user interface via an API (Application Programming Interface) to exchange prescription information, such that a user does not need or have access to the system or the controllers web interface from the physical controller. As long as the controller is powered on in the field, the controller can accept messages—including a prescription—from the web application that a user can interface with anywhere they have an internet connection.

Preferred systems compare a plot being evaluated, called a canary plot, to a reference plot. A canary plot is one of two plots within an indicator block. Indicator blocks are embedded into the field or field sub-region(s) at locations which adequately represent measurable spatial variability in soil properties and crop performance. A reference plot is one of two plots within an indicator block. In the following example, a field is broken down into regions that should be managed homogenously. Delineation of those regions is based on several data layers, preferably at least 3, that can include yield data, soil property data, and topographical data among others. Management zone is the standard language in the industry for describing these entities. Management zones are just one layer that can go into input management decisions. This is one variation for quantifying the spatial variability and placing indicator blocks. Other variations include using only the range requirement from semivariance analysis or management zones in combination with the range requirement from semivariance analysis. The indicator block is a framework in which there are at least two plots, and one of those plots will be a canary and one will be a reference. Which one is the canary and which is the reference is selected randomly. Based on that selection, each plot receives its corresponding N rate during the indicator block establishing application. The selection process is randomized to reduce any risk of uniform relative placement of the canary plot to the reference plot. For example, it could be negative if all canary plots within a field or field sub-region were on the west side of the field and were disproportionately impacted by the shade from a tall tree line late in the day. Or, if there was a hill that ran through the middle of a field sub-region north to south, and the reference plots were both to the east and sat on top of the hill, while both canary plots were to the west and sat on the slope of the hill which is more susceptible to runoff. While neither of these situations are ideal, avoiding common relative positions can be advantageous.

To adequately sample spatial variability, blocks may be placed based on management zones, range requirement as determined from semivariance analysis, or both. A management zone is an area within a field that can be managed homogenously based on exhibited similarity across measured and geospatially referenced properties. In the example approach, the sole difference is that the canary plot receives less N (preferably by 30 lb N/ac or more) than the bulk region in which it is embedded while the reference plot receives more N (preferably by at least 30 lb N/ac) than the bulk region in which it is embedded. Their locations are preferably in close proximity with each other, most preferably with a shared edge or vertex when defined geometrically. A variation can have the canary plot and reference plot paired in close proximity but not adjacent as long as they are both placed in regions that have similar characteristics, e.g. the same management zone

In preferred systems, both the canary and reference plots are served by a common irrigation system. In a variation, plots from multiple irrigation systems in a common or related geographic area used. Field variability is quantified using historical and contemporary data to determine the appropriate placement and number of sampling locations required within the field or field sub-region(s) to efficiently and accurately measure and represent nitrogen status using multispectral imagery. Indicator blocks having at least two plots, one with a reduced N application rate (canary) and one with an increased N application rate (reference) versus a bulk field area N application rate, are established at the determined sampling locations within the field or field sub-region(s) before or early in the growing season (e.g. pre-V6 for corn). Multispectral imagery is preferably obtained including the red-edge (RE) band (though other bands can be used) for field or field sub-region(s) at high temporal frequency (at least once every 7 [±2] days) throughout the growing season, beginning at the V6 growth stage or 10-14 days after the indicator blocks are established, whichever is earlier. Preferably, the imagery is obtained with a programmed unmanned aerial vehicle. Representative SI for each indicator block (SI_{block}) in the field or field sub-region(s) is calculated using the vegetation index values measured in the canary plot and mean vegetation index value in the reference plot, as shown in Equation 1 for a preferred embodiment using the normalized difference red-edge (NDRE) vegetation index, immediately following each imagery collection instance.

$${SI}_{block} = \frac{1}{n} {\sum }_{i = 1}^{n} \frac{{NDRE}_{canary , i}}{{\overline{NDRE}}_{reference}} \qquad ( 1 )$$

A logical decision tree is applied to the representative SIs for indicator blocks embedded within each field or field sub-region(s), other indicator block attributes, and cumulative N application data for the field or field sub-region(s) to produce a fertigation application decision, e.g. a binary indicator of whether or not to apply, for the field or field sub-region(s) based on each image collected.

Advantageously, the pair-wise comparison between the canary and reference plots provides a predictive capacity within a responsive management framework. Because the canary plot within each indicator block is lower in N than the bulk field or field sub-region area in which it is embedded for the entirety of the growing season, the canary plot will demonstrate nitrogen deficiency before the field or field sub-region will. Generating the representative SI for the indicator block using the canary plot vegetation index and reference plot vegetation index ensures that the canary plot sufficiency is measured using non-N-limited canopy reflectance relative to the field or field sub-region. Fertigation applications triggered by SI values for indicator blocks are proactive applications designed to prevent occurrence of nitrogen deficiency in the field or field sub-region, as they are made prior to nitrogen deficiency in the field or field sub-region being observed. Second, indicator blocks minimize the impacts of environmental conditions on image quality. Multispectral imagery, particularly image orthomosaics produced through the necessary stitching of many images captured by a UAV, is prone to image quality issues caused by clouds, shadows, wind, and leaf angle changes. Because indicator blocks include a paired canary and reference plot preferably located immediately adjacent to each other, environmental conditions are likely to affect both plots identically, allowing for reliable direct comparisons of reflectance and vegetation indices from the canary and reference plots. Finally, indicator blocks separate N stress from other crop stress in real-time throughout the growing season. Pairing these plots in close proximity maximizes the likelihood that both plots are subjected to identical stresses so that reflectance differences between the two plots are most likely caused by N rate differences. Minimizing the likelihood of other stress interference ensures that N application decisions are made on the basis of N need alone and not a mistaken alternative stress, ultimately conserving N.

A preferred system includes a power supply, an irrigation system, and a fertilizer injection pump with controllers to control the irrigation system and the fertilizer injection pump. For the automated fertigation management software used by the controller to produce accurate fertigation prescriptions for target injection rates, the software must be able to accept values defining system characteristics and incorporate those values into its calculations for each irrigation system for which the software is utilized.

A preferred system obtains images of an area being managed and from the images uses indicator blocks to quantify N sufficiency status with a vegetation index generated using crop canopy reflectance data and determine the need for and/or timing of a N fertilizer application. Indicator blocks include two or more plots, with at least one plot being established with a reduced N application rate (canary) and one plot being established with an increased N application rate (reference) versus the bulk field area in which they are embedded, established adjacently to each other in the field through a N fertilizer application with any type of application apparatus including but not limited to ground-based application equipment and irrigation systems. A vegetation index is defined as a numeric quantity generated from computational transformation of crop canopy reflectance data that is used to quantify biomass amount, crop performance, photosynthetic rates, or another similar crop health metric. Crop canopy reflectance data is defined as numeric quantities indicating the amount of light reflected in the visible, near infrared, and shortwave infrared spectra of electromagnetic radiation. N sufficiency status for a plot is quantified using an index equivalent to or reminiscent of the sufficiency index as defined in equation (2), which is a generalized version of equation (1) because when the plot is a canary plot it becomes an indicator block and “VI” is a more general vegetation index:

$${SI}_{plot} = \frac{1}{n} {\sum }_{i = 1}^{n} \frac{{VI}_{plot , i}}{{\overline{VI}}_{reference}} ,$$

where SIₚₗₒₜ is equivalent to SI_{block} when the plot is a canary.

In this case, SI_{block} is a quantity that characterizes the nitrogen sufficiency of the area in which a block is embedded. It is always equal to the SI of the canary plot. The SI for the canary plot is computed in accordance with the SIₚₗₒₜ formula provided. Therefore, SIₚₗₒₜ equals SI_{block} when the plot is a canary. Other plots within the block (reference for example) would have an SI computed according to SIₚₗₒₜ but that value would not equal SI_{block}. Need for a N fertilizer application is a binary qualification where the crop either needs to receive N fertilizer or it does not need to receive N fertilizer Timing for a N fertilizer application is based on both the crop's determined need for a N fertilizer application and the time at which that need was determined by the system based on data input to the system.

Preferred methods of the invention are implemented via software. Those knowledgeable in the art will appreciate that embodiments of the present invention lend themselves well to practice in the form of computer program products. Accordingly, it will be appreciated that embodiments of the present invention may comprise computer program products comprising computer executable instructions stored on a non-transitory computer readable medium that, when executed, cause a computer to undertake methods according to the present invention, or a computer configured to carry out such methods. The executable instructions may comprise computer program language instructions that have been compiled into a machine-readable format. The non-transitory computer-readable medium may comprise, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

A preferred system of the invention includes software configured to receive or retrieve crop canopy reflectance data for a crop in the field. It also includes software to preprocess the crop canopy reflectance data to remove non-vegetative features from the imagery data. Additional software is configured to determine crop N status from the image data of indicator blocks having at least two plots, one with a reduced N application rate (canary) and one with an increased N application rate (reference) versus a bulk field area N application rate, at the determined sampling locations within field area. Software is also configured to determine a fertigation decision based upon the N status and configure instructions for the controller or user to direct the field irrigation system and the fertilizer injection pump to provide fertigation based upon the fertigation prescription and recommendation. The system implemented in software can

Preferred embodiments of the invention will now be discussed with respect to experiments and drawings. Broader aspects of the invention will be understood by artisans in view of the general knowledge in the art and the description that follows.

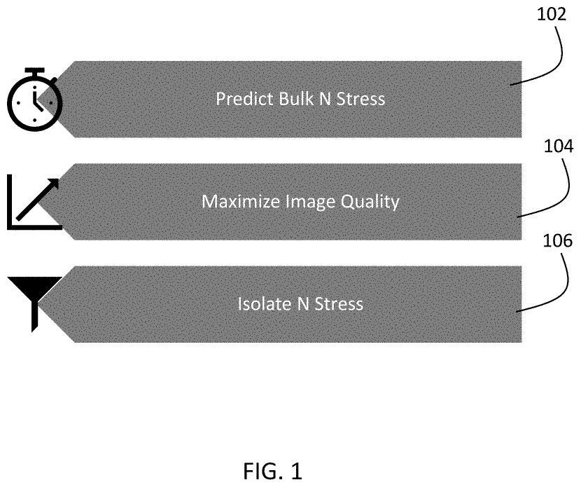

FIG. 1 illustrates important modules of preferred fertigation systems, methods and data structures. A predicted representative SI (sufficiency index) module 102 predicts bulk N stress based upon Eqs. (1) and/or (2). Image quality from obtained images is maximized in a module 104 via techniques including image preprocessing that eliminate non-relevant image areas from the SI analysis. N stress is isolated 106 through the configuration of the paired plots and execution of Eq. (2) to make real-time and high-frequency fertigation decisions, preferably for the field or field sub-region(s) (sector) to maximize applicability.

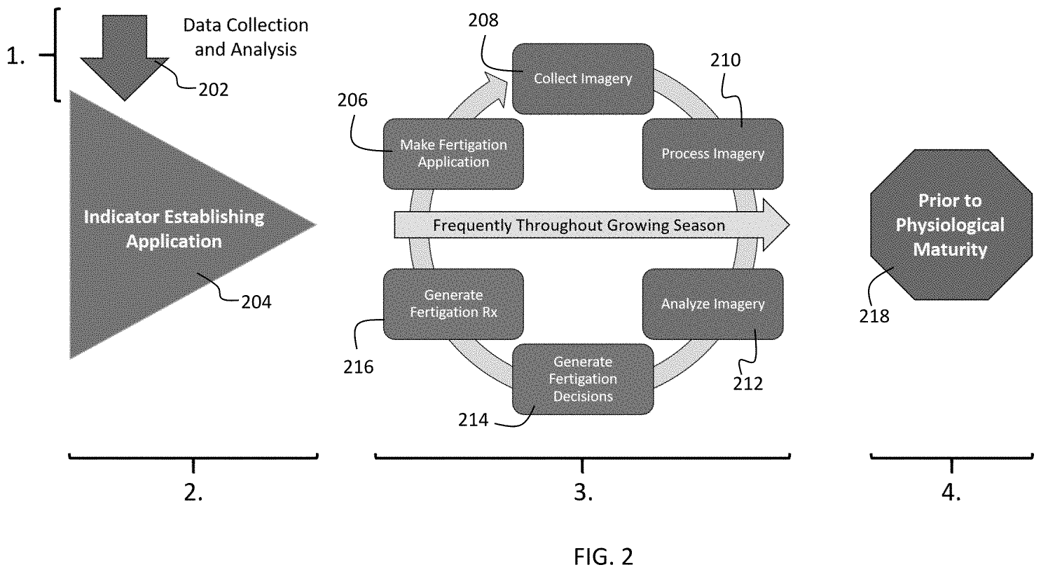

FIG. 2 illustrates the overall process flow for a preferred method that was tested in the experiments discussed below. Preseason data collection and analysis 202 can include site setup (e.g. management zone generation, database attribute population, etc.) for a location having its first year of fertigation control with a system of the invention or for a location having updated zones, etc. An indicator establishing application/module 204 establishes initial nitrogen application at or prior to the V6 growth stage. An initial fertigation is conducted 206 to establish paired plots of adjacent canary and reference plots in each of a plurality of sectors of the field. Imagery of the site receiving controlled fertigation is collected 208, e.g. via UAV flights. After imagery for the irrigated field or field sub-region(s) is collected the imagery is processed 210 and analyzed 212. The processing 210 preferably includes intelligent preprocessing to eliminate non-crop features that could affect the fertigation analysis, e.g., eliminate access roads, fences, treed areas and other non-planted areas. Analysis 212 preferably includes the pair-wise comparison discussed above with canary plots and reference plots. This analysis permits fertigation decisions to be determined 214 by a module for the field or field sub-region(s), and the fertigation plan is determined 216. This is preferably done on a high-frequency basis, e.g., weekly during the growing season, and then the system/method stops fertigation operations 218 prior to physiological maturity. The method in FIG. 2 can be considered to be in four phases marked in FIG. 2, with a first phase being initial data collection, a second phase being initial application, a third phase being active fertigation control and a fourth phase ending the fertigation control.

In preferred systems the site image collection 208 collects multispectral image data from cameras mounted on a remote sensing platform, e.g. UAVs, airplanes, and satellites. When processed in step 210, the data are preferably stored in a GeoTIFF file format. Other data storage formats can be used if the format associates image data with geospatial reference information included in the file metadata.

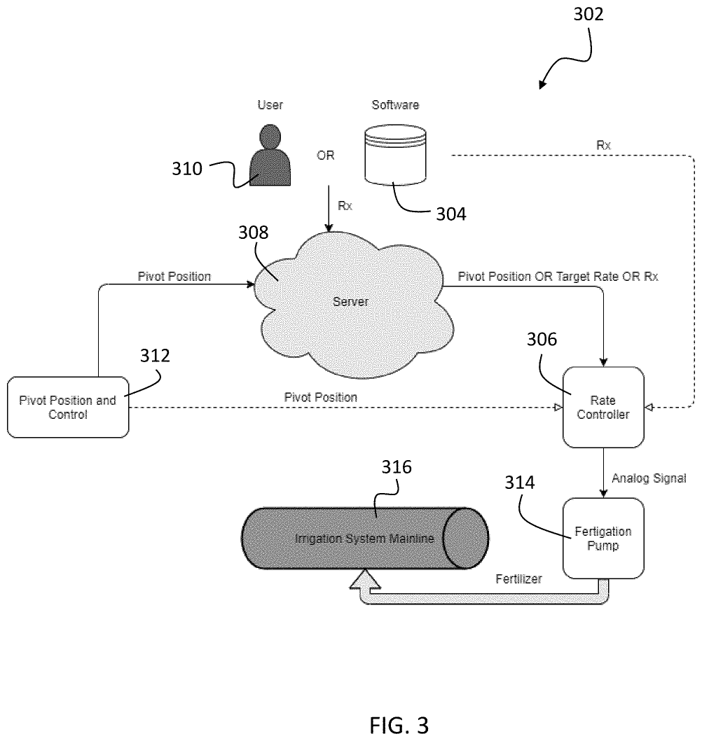

FIG. 3 illustrates an example preferred system 302 for center pivot irrigation, with various options illustrated based upon system configuration. Fertigation control software 304 executes the pair-wise plot analysis for high-frequency fertigation automated methods provides a fertigation prescription Rx according to FIGS. 1 and 2. Specifically, the software 304 executes the paired-plot analysis, thereby producing the Rx that contains the target rates to be executed by a rate controller 306. The Rx is provided to the rate controller 306 with target rate from a server 308 or a user 310 (such as at a local input station for the system 302). A pivot position controller 312 provides pivot position updates to the server or local computer/input station. The rate controller 306 instructs a fertigation pump 314 that connects to a mainline 316 of an irrigation system. Typical fertilizer injection (fertigation) pumps are positive displacement pumps that pump at a constant rate while powered on. The fertigation pump 314 is preferably a variable rate fertilizer injection pump, which enables control of the pump injection rate using a variable frequency drive (VFD) and an analog input (typically 0-10 V or 4-20 mA) that is linearly mapped to pump output and determines the frequency output of the VFD. The rate controller 306 can be either external to or embedded in the variable rate injection pumping system 302 and accepts positional target rate information from the server 308 or user input station, e.g., in the form of a tabular prescription and translates target rate information to analog input values throughout a fertigation event to spatially vary the application rate. Variable rate injection pumps and rate controllers are equipped with telemetry that enables real-time data transmission to and from equipment. During variable rate fertigation applications, center pivot position is determined using a GPS receiver on the end tower and transmitted either to the server 308 (cloud) or directly to the rate controller 306. The measured pivot position determines the target rate for the rate controller to actuate the analog input signal to the pump. The CropLink® (AgSense, Huron, S. Dak.) is one such commercially available control unit that can server as the rate controller 306. The CropLink® accepts prescriptions as tables requiring each row to include a start degree, stop degree, and hertz (Hz) on a 0-60 scale attribute. The CropLink® works in conjunction with the Field Commander® (AgSense, Huron, S. Dak.), a pivot positioning and remote-control system, to determine appropriate target rates during an application. Prescription tables for the CropLink® can be uploaded to a server through a web interface as a .csv file. The system software 304 can maximize integration with physical application systems, by having the ability to output prescription files that are compatible with the requirements of commercially available rate controllers such as the CropLink®. With regard to configuration options, if the Rx is stored in the cloud 308 and not on the rate controller 308 in the field, then a target rate is reported to the rate controller 308 which is attached to the machine. Otherwise, if the prescription is stored in the rate controller 308 in the field, then the server reports the pivot position which is then referenced against the Rx by the rate controller 306 in the field and the target rate is chosen based on that cross-reference by the controller 304.

While it is preferred that the fertigation pump 314 is a variable rate pump, the invention can also be used to control constant rate fertilizer injection pumps. With a constant rate pump, the prescription provides an appropriate gallons per hour injection rate corresponding to specified irrigation parameters.

A preferred system is exemplified by a prototype. The prototype was developed in MATLAB® (The MathWorks Inc., Natick, Mass.) and interfaces with a multi-table SQLite database having a preferred data structure. Tables included in the database are “Pivots,” “Products,” “Sites,” “Users,” and “Images.” The “Pivots” table includes all relevant information about the center-pivot irrigation systems for fields being managed using the system. The “Products” table includes important parameters for N fertilizer products potentially applied via fertigation. The “Sites” table includes important information specific to each site including filepaths to important geospatial files used in executing automated processes, file directories for saving generated information, and crop production parameters used to generate fertigation decisions. The “Users” table contains information specific to each user of the program (e.g. crop consultants, growers, researchers, etc.). The “Images” table contains records of pertinent information relating to each image used by the program including date of capture, image instance, and crop growth stage at the time of image capture. The developed prototype consists of a control script for directing program flow and module scripts which the control script calls to perform specific process functions.

Prototype functions are also implementable as a preferred system involving a graphical user interface (GUI), with the control script replaced by a multi-window GUI framework that calls the component modules as needed to execute the process. As mentioned, another variation is a web application.

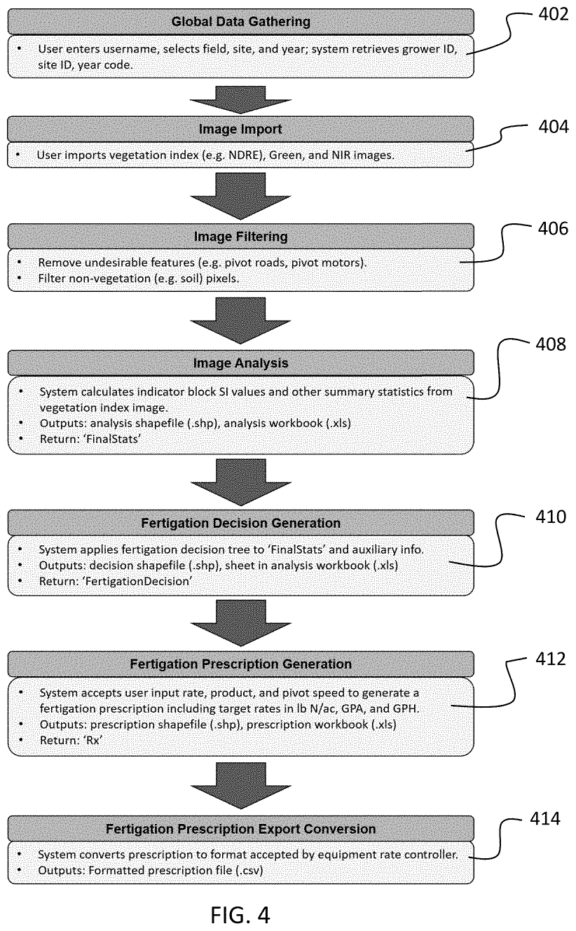

FIG. 4 shows the preferred prototype program modules and the flow of the module operation: global data gathering 402, image import 404, image filtering 406, image analysis 408, fertigation decision generation 410, fertigation prescription generation 412, and fertigation prescription export conversion 414. Each component calls at least one function to generate the expected outputs. Image analysis 408, fertigation decision generation 410, fertigation prescription generation 412, and fertigation prescription export conversion 414 each call specialized functions—sometimes referred to as modules—written to modularize the control script which facilitates code improvements without significant ripple effects. Details regarding program flow, control script functionality, module design, and outputs of the program are discussed further below.

Program flow begins with global data gathering 402, which consists of the user first logging into the program and selecting the site and year for which to run the program followed by extraction of important site parameters and directory information from the database. Critical data used by multiple modules and throughout the control script are stored in global variables. Following base data gathering, the control script proceeds to image import in which the user selects the vegetation index image, green band image, and NIR band image from a file directory user interface.

User input for the selection could also be automated with user collected imagery (whether downloaded from a third-party or captured themselves), so long as the images are consistently appropriately labeled in the metadata and placed in the same directory. Some user prompts provide flexibility by launching a file explorer window that allows the user to select the appropriate file(s) to import. Once they have selected them, all import processes are automated. In one preferred implementation, the system can automatically pull imagery with module 404 from an image provider such as Planet Labs (satellite imagery) or Farm Flight (UAV imagery) which have APIs that third parties can interface with. An API can be constructed and replace the user input steps without altering overall process flow.

Once images are selected, the next step in the program is image filtering 404, which conducts preprocessing. In image preprocessing, images are cleaned for random features such as pivot roads, center pivot laterals, and in-field motors using featremove module and soil pixels are filtered from the image through removesoil module. The soil pixel removal module is controlled by the script to only run prior to closure of the crop canopy and relies on frequency filtering of the green and NIR band images to identify soil between crop rows. Preliminary validation of this algorithm was completed by verifying the alignment of identified vegetation pixels with row-by-row planting data. Preprocessing images is important to the accuracy of quantitative analytics, particularly when high-resolution images are analyzed.

Upon completion of preprocessing, images are analyzed 408 through ImSuffAnalysis module. The prototype software is agnostic to the platform used to collect the imagery as long as imagery is in a GeoTIFF image format. Alternative image formats including geospatial reference information in the image metadata could be used in variations of the system. The expected image input is a vegetation index image, such as the NDRE GeoTIFF produced by Pix4D Mapper, a commercially available image stitching software. NDVI or other vegetation index images can also be used in the prototype software, though NDVI images (particularly for corn crops) are not recommended for use once the crop has reached full canopy. Standard and minimum SI thresholds (SI_{std} and SIₘᵢₙ, respectively) for imagery analysis are set in the control script and passed as arguments to ImSuffAnalysis module. ImSuffAnalysis module imports several geospatial layers as shapefiles to use in analyzing the NDRE image.

Geospatial data layers imported delineate the boundaries of indicator blocks embedded into the field or field sub-regions (CR_plots), delineate the union of management zone boundaries and field or field sub-region boundaries with embedded indicator block area subtracted (Sector MZC), and delineate the union of management zone boundaries and field or field sub-region boundaries with embedded indicator block area retained (Sector MZ):
1. CR_plots: A geospatial data layer containing the boundary coordinates and additional attributes of polygonal plots (e.g. canary plot, reference plot) within indicator blocks, including a pair identification number;
2. PlotMZC: A geospatial data layer containing the boundary coordinates and additional attributes of polygonal management zones clipped to field or field sub-region(s) boundaries with indicator block regions subtracted from the polygonal area;
3. PlotMZ: (Optional) A geospatial data layer containing the boundary coordinates and additional attributes of polygonal management zones clipped only to the field or field sub-region(s) boundaries.

ImSuffAnalysis module analyzes imported imagery according to the management approach assigned to the selected site in the database. For the indicator block method, ImSuffAnalysis module analyzes the imagery using a ‘for’ loop that iterates through each indicator block comprising plot within the CR_plots geospatial layer. In each iteration, the script identifies pixels that fall within the plot boundary, computes the SI for each pixel in the plot by dividing the pixel vegetation index value by the corresponding reference plot mean vegetation index value, and computes summary statistics (mean, standard deviation, maximum, minimum, median, and range) for the plot SI and vegetation index. Computed values are stored in a new table. The process—except the calculation of summary statistics—can be generalized from Equation (1) as shown in Equation (2).

Consequently, when the plot for which the process is completed is a canary plot, SIₚₗₒₜ is calculated identically to SI_{block}. Therefore, the computed SI for the canary plot is equal to SI_{block} for the indicator block to which that canary plot belongs. Prior to entering the ‘for’ loop, the CR_plots table is sorted such that the reference plot computations are performed first which ensures that reference plot mean vegetation index values are computed and available for reference during all canary plot computations. Following iteration through the CR_plots table, base sufficiency status and minimum sufficiency status are assigned as a ‘Yes’ or ‘No’ value to each plot based on the SI_{std} and SIₘᵢₙ thresholds, respectively. Once sufficiency statuses are assigned, the new table containing geospatial information and computed values for each plot is sorted by field sub-region ID, zone, and type in ascending order.

A similar process is used to compute the sufficiency of bulk field or field sub-region crop area regardless of the management method for the field or field sub-region based on the PlotMZC geospatial data layer, with the only difference being that the maximum reference plot mean vegetation index for the field or field sub-region is used to compute the field or field sub-region's SI. Computed values and geospatial information for the field or field sub-regions and indicator block comprising plots are combined into a comprehensive table once calculations are complete. ImSuffAnalysis module has two exported outputs:
1. A shapefile containing all computed values and inherent attributes included in the comprehensive table that can be opened and mapped in any geospatial software capable of interpreting shapefiles;
2. A .xls file that contains three sheets—“IndicatorStats,” “BulkStats,” and “CompStats” (sheets contained within the .xls workbook produced. “FinalStats” is a data structure returned for use in the program whereas the rest are exported in that workbook for storage/recordkeeping/etc) which contain all computed information and inherent attributes for the indicator block comprising plots, field or field sub-regions, and those two types of regions combined, respectively.

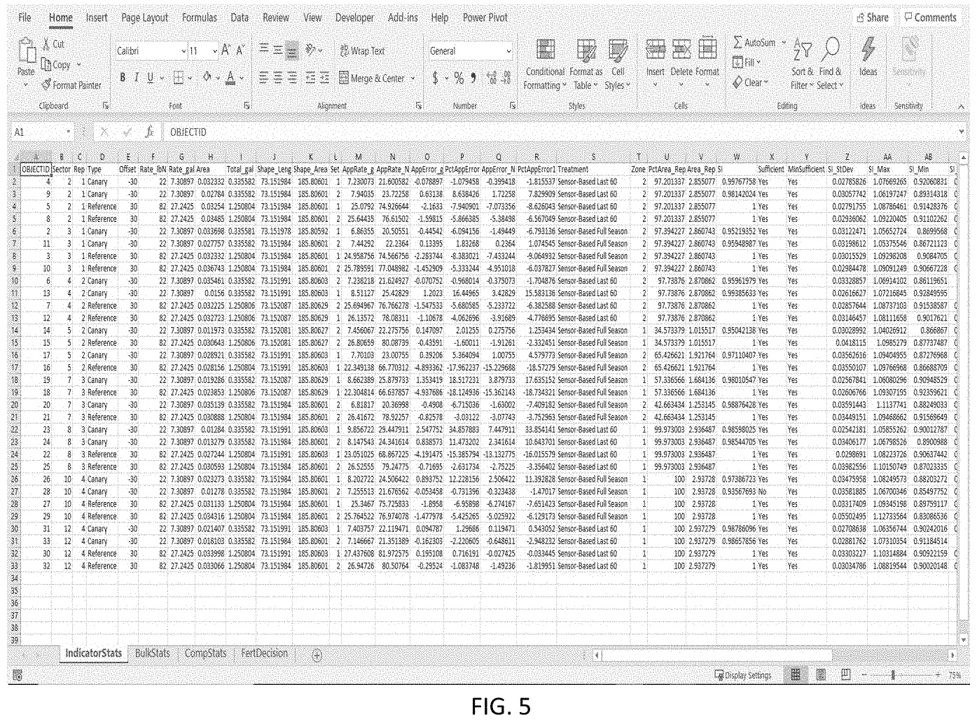

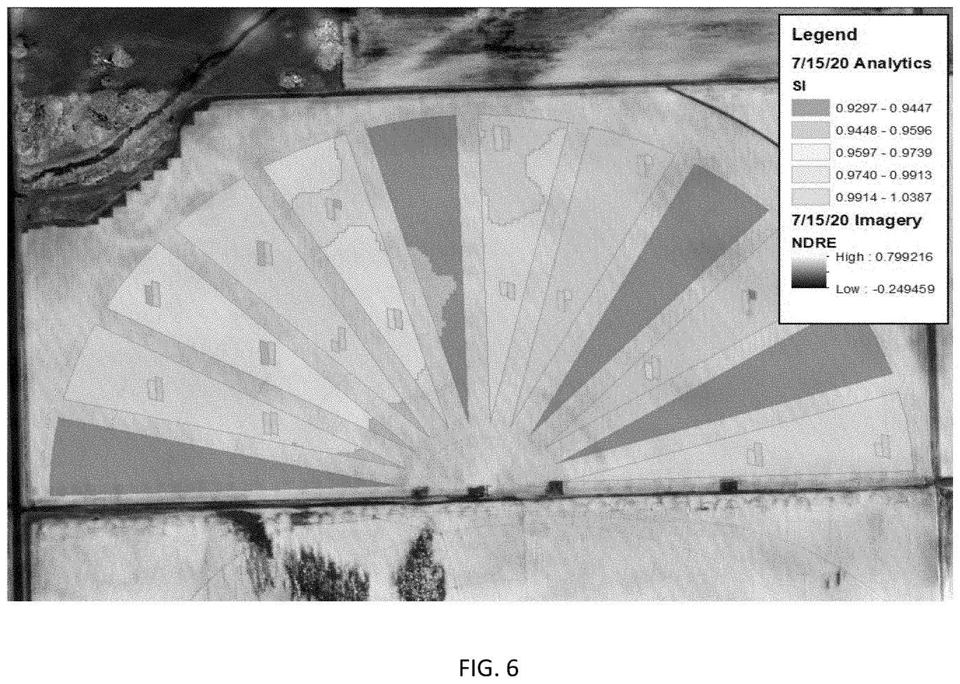

Example exported outputs opened in Microsoft Excel and ESRI ArcMap are shown in FIGS. 5 and 6, respectively. ImSuffAnalysis module finally returns the geospatial information, inherent attributes, and computed values for the indicator block comprising plots to the control script as FinalStats for use in subsequent control script operations. The representative SI for each block is included in FinalStats as the SI for the canary plot in each block.

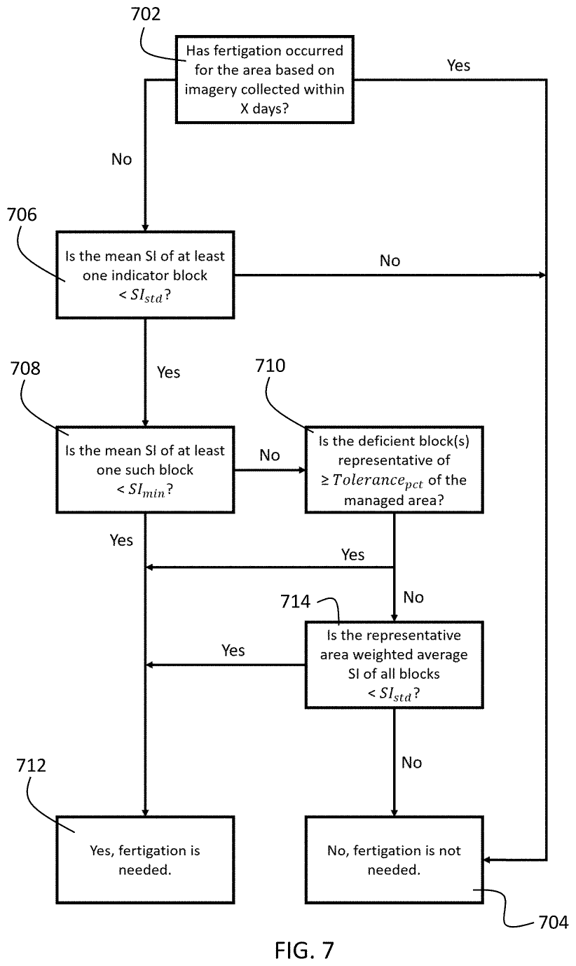

Once image analysis 408 is complete, the control script initiates the fertigation decision process through FertDecision module 410 which takes several input arguments including FinalStats. First, FertDecision module 410 imports a N application log file as a table, retrieves the most recent image date, total N goal for the field, and most recent crop growth stage from the database, and imports the field or field sub-regions geospatial data layer in shapefile format to use as a template for decision shapefile generation. The date of the most recent fertigation application, day difference between that application date and the date of the most recent imagery event, and cumulative nitrogen applied per field or field sub-region are determined based on information in the N application log file. This information is then used conjunctively with information from FinalStats in a series of conditional statements actuating the logic depicted in the decision tree shown in FIG. 7. Final outputs of FertDecision module 410 include a shapefile of managed areas with added fertigation decision attributes and a table of fertigation decisions for managed areas appended as an additional sheet to the .xls workbook produced by ImSuffAnalysis module.

FertDecision module 410 returns a table of fertigation decisions to the control script for use in subsequent functions. Fertigation decisions are made for every field or field sub-region based upon the following strategy. Indicator blocks consisting of at least a low N (canary) plot and a high N (reference) plot are embedded within each field or field sub-region. Field sub-regions may be delineated a multitude of ways. There must be at least two indicator blocks within each field sub-region and typically more within a field without field sub-regions. Indicator blocks are placed such that they sample the crop at a resolution that matches variability in crop performance and purposely variability in response to N. Collectively, the representative SI values for indicator blocks (equal to the SI measured for the low N plot) are used in the fertigation decision tree to make fertigation decisions for the field or field sub-region(s).

The table of fertigation decisions serves as an input argument to the setrate module function 412 which performs the next action of the control script—setting fertigation application rates in lb N/ac. In one variation, setrate module 412 can generate several user interface dialog boxes asking a user if the user would like to change default application rates for the field or any field sub-region(s). In another preferred variation, the GUI allows a user to adjust application rates within a table in the prescription generation tab of the main application window. Default application rates are preferably defined in the database by the user during site setup, or using the software's default settings. The function setrate module returns the table RxRate to the control script. Following user confirmation of application rates for the field or field sub-region(s) and return of RxRate, the control script proceeds to the prescription generation process.

The control script calls the function FertRx module 412, which takes input arguments including the fertigation decision table (FertigationDecision) and the application rate table (RxRate), to generate the output ‘Rx’, a variable rate fertigation pump prescription table. The module requests several user inputs including the fertilizer product to be applied, intended date of application, and pivot speed during the application. FertRx module 412 retrieves fertilizer product name and density (lb N/gal) from the ‘Products’ table in the database, as well as the following values from the ‘Pivots’ table in the database.
1. Minimum Revolution Time (hrs)
2. Minimum Depth (in.)
3. Area Covered by Pivot Span Only (ac)
4. Area Covered Including End Gun (ac)
5. End Gun Starts—1, 2, 3, and 4 (degrees)
6. End Gun Stops—1, 2, 3, and 4 (degrees)

From the ‘Sites’ table in the database, FertRx module 412 retrieves the following values.
1. Well Water Nitrate (ppm)
2. Controller Output at 0 V (Hz)
3. Controller Output at 10 V (Hz)
4. Pump Injection Rate at 0 V (gph)
5. Pump Injection Rate at 10 V (gph)

Using the retrieved values for the controller frequency and pump injection rate values at 0 and 10 V, FertRx module 412 constructs a linear transfer function for computing frequency values from fertilizer injection rates. FertRx module 412 then imports a table of field or field sub-region IDs, start degrees, and stop degrees generated during the field or field sub-region delineation process. Based on that table, FertRx module 412 assigns fertigation application rate(s) in lb N/ac to the field or each field sub-region and writes the information to a prescription shapefile. Because current variable rate controllers and pumps accept prescriptions only in non-shapefile tabular formats with particular units used to specify target rates, FertRx module 412 proceeds to generate an Excel spreadsheet file (.xls) with the prescription in table format. If the injection pump for a particular site is capable of variable rate applications, FertRx module 412 first determines whether or not the end gun is on for each field sub-region and splits field sub-regions within which there is a change in end gun operational status. The end result of this process is a series of field sub-regions for which the end gun is either off or on, with each field sub-region child created in the process retaining its parent's ID and other attribute information. FertRx module 412 then calculates required gallons per acre of fertilizer based on the lb N/ac target rate adjusted for N in the irrigation water and the product density. Next, the coverage rate (ac/hr) is calculated for each field sub-region based on end gun operational status for a field sub-region, the speed of the pivot, and the total area coverage at that location. Fertigation rate controllers do not automatically adjust for changes in area covered due to end gun flow and flow compensation is not typically enabled even on variable rate fertigation pumps to adjust injection rates for additional end gun coverage. Therefore, the prescription produced by FertRx module 412 preferably compensates for required changes in injection rate to ensure accurate applications with simultaneous end gun operation. FertRx module 412 compensates for end gun operation areal coverage dynamics by multiplying the calculated gallons per acre target rate for a field sub-region by the areal coverage rate in acres per hour to calculate the target injection rate in gallons per hour for each field sub-region. For constant rate injection pumps, the same process is completed if an end-gun will be operated during the application, but only the highest expected injection rate required based on the areal coverage rate when the end-gun is on is included in the prescription. The gallons per hour injection rate is translated to Hz for potential rate controller usage through the linear transfer function computed previously. Additional attributes calculated for the field or each field sub-region include acres covered, total gallons of fertilizer applied, and time of application. All attributes are included in the final prescription table and exported to the first sheet within the prescription workbook. Finally, the acres covered, gallons of fertilizer applied, and time of application are totalized across the field or field sub-region(s) and exported to the second sheet within the prescription workbook along with other application parameters.

The final stage of the control script is conversion 414 of the generated prescription into an appropriate format and file type for transmission to the rate controller. In the prototype script, a conversion function is included to convert the prescription generated by the software into the format required by WagNet, the online interface for the FieldCommander® and CropLink® rate control system. Inputs to the conversion function are the Rx table and two global variables. The function outputs a .csv file with a start degree attribute, a stop degree attribute, and a Hz value corresponding to the proper GPH injection rate. All degrees from 0 to 360 are represented within the table and a terminal table row of 0 values for all attributes is included to facilitate upload success since the upload interface eliminates the final row of the .csv.

Supporting software components to automate other operational aspects of the fundamental method implementation are valuable for speeding and making fertigation systems and methods of the invention more commercially valuable. In this regard, a functional prototype script has been developed for post-processing as-applied data from the indicator block establishment application to produce a shapefile containing all canary and reference plots. This shapefile is used in subsequent high-frequency image analytics and prescription generation cycles. Inputs to the as-applied post-processing scripts are the as-applied data in point shapefile format, the indicator establishment prescription file in polygon shapefile format, field or field sub-region boundaries in polygon shapefile format, management zone boundaries in shapefile format, and buffered pivot tracks in polygon shapefile format. The most important outputs of the script are the indicator block comprising plots polygon shapefile (CR_Plots), the management zone clipped to field or field sub-region polygon shapefile (PlotMZ), and the management zone plus field or field sub-region with indicator block subtracted polygon shapefile (PlotMZC) which are used in ImSuffAnalysis module. These layers and their role in image analysis are defined in detail above. Prototype scripts have also been developed for management zone delineation, field or field sub-region delineation, pivot track boundary generation, and pivot information input. These make up the majority of necessary operations for implementing this sensor-based fertigation management protocol at commercial scale.

### EXPERIMENTS

Preferred methods were tested for efficacy in managing fertigation for center-pivot irrigated corn production during on-farm research trials over two growing seasons. On-farm research trials were executed using a variable rate fertigation pump with treatments implemented in pie-shaped field sub-regions with an angular dimension of 15° and length equal to that of the center pivot irrigation system lateral.

A preferred fertigation decision tree that can be implemented in the fertigation decision generation module 410 is shown in in FIG. 7 and was used in the experiments. The decision logic first checks for the last fertigation 702 that occurred in an area (plot) being considered for a predetermined period of time (X days). If the plot had been fertigated within the predetermined number of days, then the decision is no fertigation 704 for the plot. If the plot had been fertigated within the predetermined number of days, then analysis begins with images provided by the image analysis module 408. Mean SI is tested 706 for indicator blocks (plot) within the plot. Indicator blocks are embedded within large areas (field sub-regions/sectors) and are representative of the field sub-region/sector in which they are embedded. Step 706 can be summarized to mean that if at least one indicator block embedded in the field sub-region has an SI block value less than SI std, then “Yes,” else “No.” If no block has mean SI less than the standard SI (SIstd) then the decision is no fertigation 704, and if a block does then it is tested against the SI minimum SImin 708. SI block values below the SI std value indicate nitrogen deficiency. In other words, SI std is the primary SI threshold value. If it is not less than SImin testing against a tolerance percentage Tolerancepct. If it is less then SImin, then a fertigation decision is made 712. The fertigation decision 712 is also made when the Tolerancepct 710 is exceeded, and if not the representative area weighted average SI of all blocks less than standard SI (SIstd) 714 the fertigation decision 712 is also made, and otherwise the no fertigation decision 704 is made. Area weighted indicates multiplying each SI block value by the fractional proportion of the field sub-region area it represents and summing the products. Eq 1 or Eq 2 for a canary plot (equal to SI block) produces the SI block value. Then, the area-weighted SI is computed by summing the products. Prescription accuracy was verified through simultaneous manual prescription generation using a formatted Excel spreadsheet. Successful uploads of the .csv file formatted for the user interface occurred. The percentages and thresholds within the decision tree of FIG. 7 may change, but the general decision framework is static. Tuning of the thresholds and parameters gives the algorithm the flexibility to adapt to different management styles and environmental conditions (soil types, climate, etc.). Commercially, users—both farmers and consultants—will appreciate the opportunity for flexibility. Fertigation decisions produced by this algorithm could be used to inform prescriptions for fertigation through any type of irrigation system.

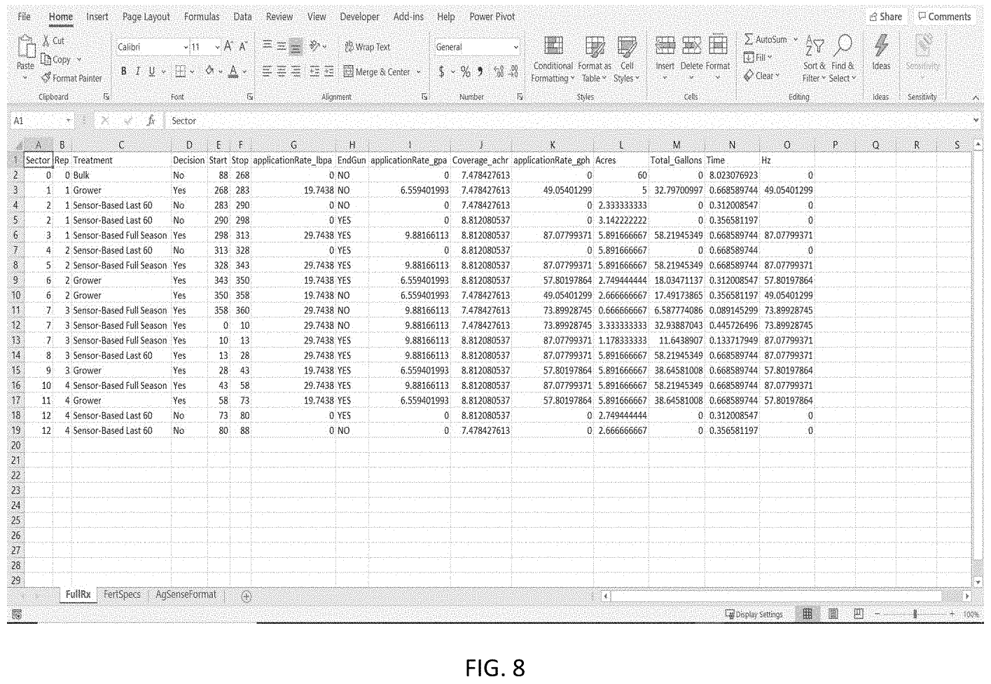

An example prescription software output is shown in FIG. 8. The table includes rep and treatment information for research functionality that can be removed easily for other applications. FertRx module 412 returns the table ‘Rx’ to the control script for continued operation. It is important to reiterate that for the simplified prescriptions generated for constant rate pumps, there would be no-field sub-regions and the injection target rate would be automatically adjusted to the rate necessary to supply adequate N during end-gun operation, if the site operates using an end-gun during fertigation applications.

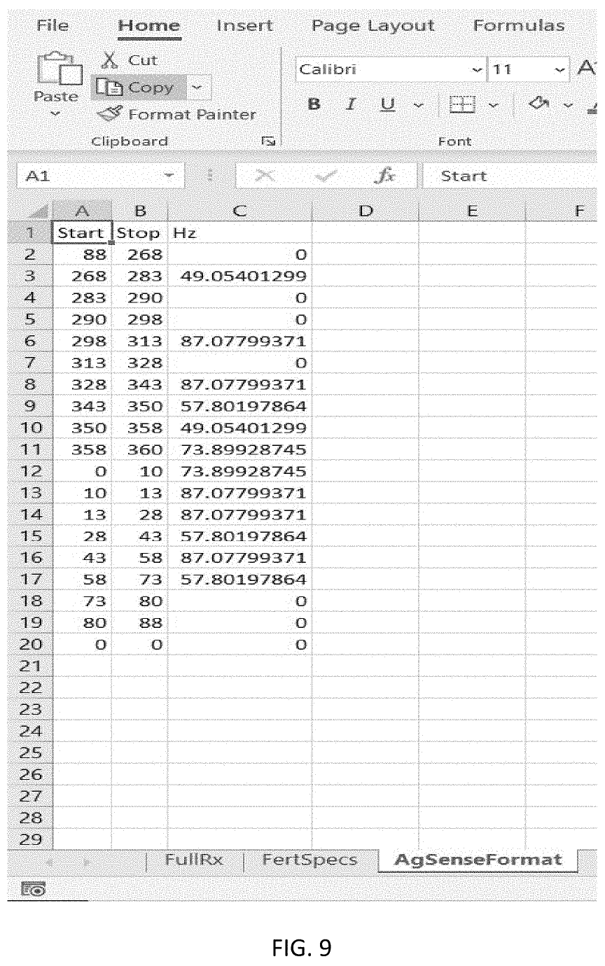

An example of a formatted table for the user interface is included in FIG. 9. A prototype script for conversion of produced prescriptions can conduct the export conversion 414. The purpose of this conversion script is to provide for transmission of files directly to rate control interfaces via an API without any human intervention.

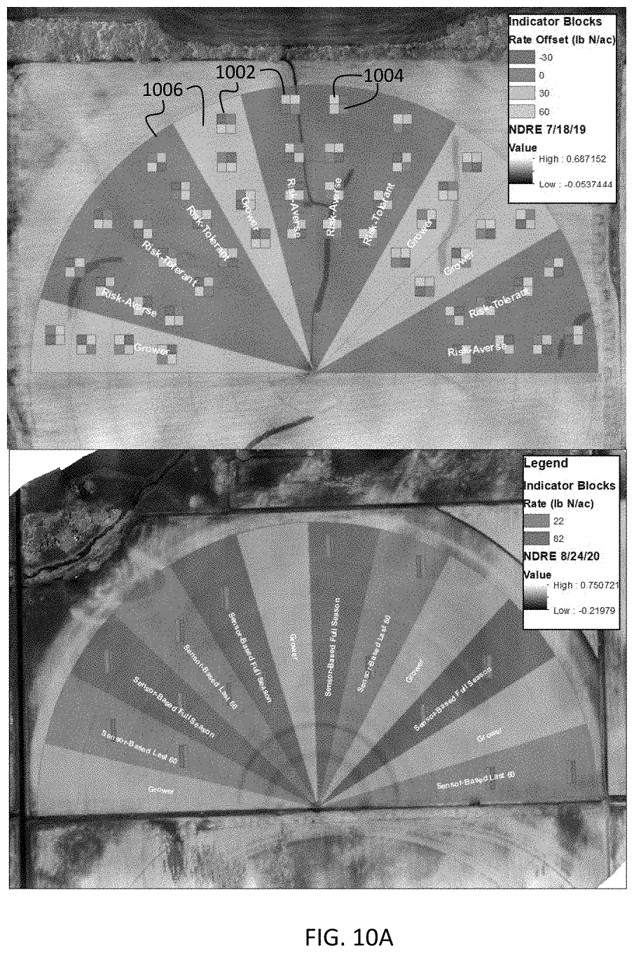

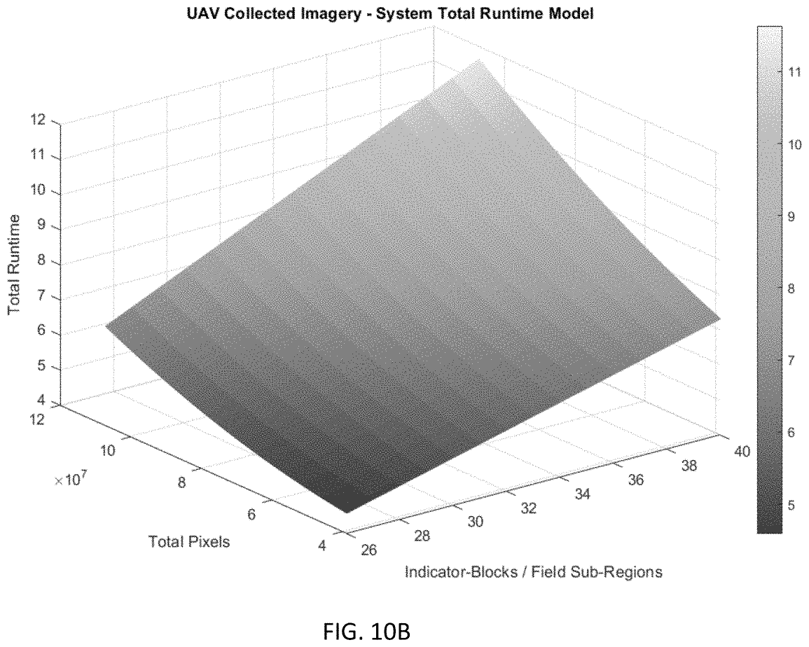

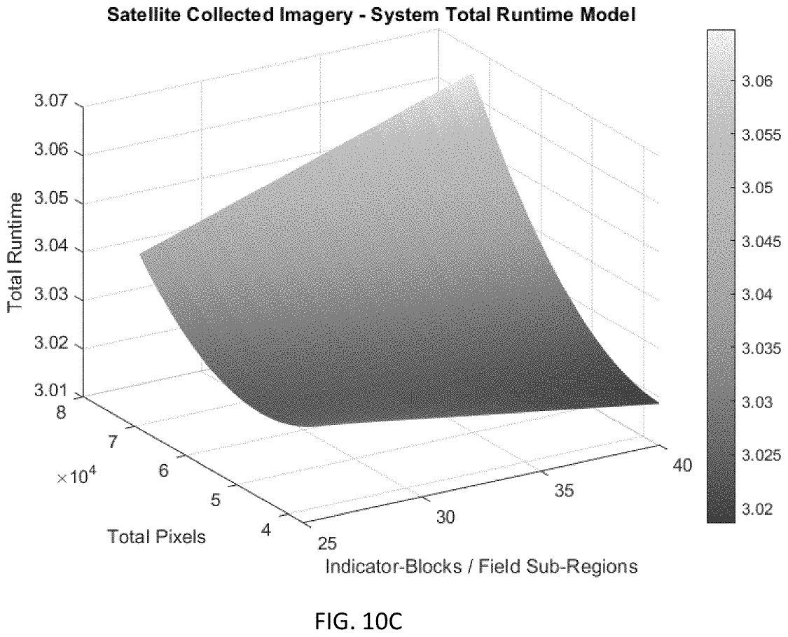

Examples of field trial field sub-region layouts are provided in FIG. 10A. FIG. 10A shows indicator blocks 1002, each having 4 plots 1004, in a plurality of sectors 1006. The paired plots 1004 are created in each sector 1006, as discussed with respect to the initial fertigation application 206. In the example of FIG. 10A, the sectors 1006 include differently managed sectors, i.e., grower managed, risk-tolerant and risk averse sectors. The adjacent plots in each sector are paired to create indicator blocs, having four different levels, a canary level of −30 lb N/ac, a standard level (assigned amount for the sector) and two reference levels of +30 and +60. This allowed testing of both a risk-averse and a risk-tolerant approach—against typical grower management during the 2019 growing season through completely randomized block design trials at five commercial corn fields in Nebraska managed by five different growers. Both approaches only used sensors to inform fertigation decisions for the last 60 lb N/ac applied to each field. The parameter being tuned for optimization in the 2019 trials was the area representation threshold (Tolerance_{pct}) required to trigger a fertigation application. SI_{std} was equal to 0.95. In the risk-averse approach, Tolerance_{pct} was equal to 25%. Therefore, if an indicator block representing at least 25% of the area in the field sub-region in which it was embedded measured a representative SI less than SI_{std} a fertigation application was triggered, provided that the prior application to imagery collection interval was met. The risk-tolerant approach used a Tolerance_{pct} of 75%. Therefore, if an indicator block or block(s) representing at least 75% of the area in the field sub-region in which it was embedded measured a representative SI less than SI_{std} a fertigation application was triggered, provided that the prior application to imagery collection interval was met. Generally, the risk-averse strategy was designed to prioritize yield protection while the risk-tolerant strategy was designed to prioritize N savings. The risk-averse strategy best balanced NUE and profit, though the data showed the potential for earlier season fertigation applications to make a more positive impact on crop performance. In 2020, the primary goal of conducted on-farm research trials was to investigate full-season sensor-based fertigation management using the risk-averse strategy versus both typical grower management and sensor-based fertigation management using the risk-averse strategy for only the last 60 lb N/ac applied. On-farm research trials were conducted at 4 commercial corn production sites and 1 commercial-scale research farm site in 2020. Though the research farm trial did not include a typical grower management treatment, data was gathered for sensor-based management as implemented in the full-season sensor-based management treatments in the on-farm studies. Additional treatments investigated different rate block implementation methods and alternative sufficiency measurement protocols.

In both the 2019 and 2020 growing seasons, indicator blocks were established in one pre-V6 application using variable rate capable ground equipment. During this application, the field sub-region areas outside of the embedded indicator blocks (known as the bulk field area) received a uniform nitrogen application rate. The size and rates chosen for indicator block establishment were adjusted in consecutive years to optimize method performance and implementation ease. In 2019 on-farm research trials, the reference plots were 60 lb N/ac above the bulk field area rate whereas in 2020 the reference plots were 30 lb N/ac above the bulk field area rate. In both years, the canary plots were 30 lb N/ac below the bulk field area rate. The decision to reduce the reference rate offset was based on data from the 2019 growing season demonstrating little difference in NDRE and SI between embedded plots receiving 30 lb/ac more N than the bulk field area throughout the growing season and adjacently grouped reference plots receiving 60 lb/ac more N than the bulk field area throughout the growing season. The size of indicator blocks used was also changed between 2019 and 2020 in order to better align application requirements with application implement capability and ensure accurate indicator block establishment. Individual plots within indicator blocks were 40 ft wide by 40 ft long during the 2019 growing season. Analysis of the as-applied data from the indicator block establishing application revealed that the length of the plot in combination with the rate change magnitudes created poor performance conditions for application equipment leading to inconsistency in establishment accuracy. In 2020, plot length was increased to at least 100 feet. Plot width varied depending on the implement used, but generally individual plots were 40 feet wide. In total, each indicator block in 2020 occupied a total area of approximately 0.18 acre between the relevant canary and reference plot.

Indicator blocks were implemented in a configuration designed to capture crop N requirement spatial variability within the field or field sub-regions. As referenced above, blocks may be placed based on management zones, range requirement as determined from semivariance analysis, or both. In 2019, the semivariance approach was used with the range requirement based on historical yield data, resulting in four indicator blocks placed in each field sub-region, each representing roughly 25% of the region in which they were embedded. A combined approach was used for the 2020 growing season in which management zones were the dominant placement factor as long as the range requirement from a semivariance analysis of soil samples for N was satisfied. Management zones were derived using four measured attributes: elevation, slope, soil electrical conductivity (soil EC), and historical yield. Management zones were generated using a k-means clustering algorithm that optimized for the appropriate number of zones between 2 and 6 by maximizing the Calinski-Harabasz index. At least one indicator block was placed in each management zone within each field sub-region, and more indicator blocks were placed as necessary to satisfy the range requirement resulting in at least two indicator blocks in each field sub-region across all experimental sites. A comparison of sample treatment plot maps between 2019 and 2020 with indicator blocks shown is provided in FIG. 10A.

Following the indicator block establishing application, multispectral imagery was collected weekly beginning at the V6 growth stage and the NDRE vegetation index was calculated using the RE and NIR bands. A UAV with a Parrot Sequioa camera was predominantly used for image capture, but satellite collected aerial imagery providing R and NIR bands for NDVI calculations was used in rare early season instances during 2020 when wind conditions prevented drone flights. Use of NDVI early in the season was allowed since the corn crop had not yet reached full canopy. Following calculation of the NDRE values, images were preprocessed to clean out undesirable features and analyzed to generate representative SI values for each indicator block in the field sub-regions. Those SI values were then used in the decision tree analysis of FIG. 7 to generate binary fertigation decisions for the field sub-regions. The logic in the decision tree used to generate fertigation decisions in 2020 was according to FIG. 7 in accordance with preferred embodiments above. After fertigation decisions were made, a variable rate fertigation prescription was generated since on-farm research was executed using a variable rate fertigation injection pump. All field sub-regions requiring a fertigation application received fertigation at a rate of 30 lb N/ac. Accompanying irrigation depths varied according to grower preferences as long as the injection rates required to achieve the target N application rate for that depth of application were within the operating range of the injection pump. Fertigation applications were made as soon as possible following prescription generation. Applications were not allowed to occur for a field or field sub-region based on imagery captured less than 8 days after the most recent fertigation event in order to ensure that applied N had been incorporated at the time of reflectance measurement. The entire process—image capture, image analysis, fertigation decision, prescription generation, and fertigation application—was repeated throughout both growing seasons until corn reached the R3 growth stage at the time of image collection. The process was the process shown in FIG. 2 discussed above.

Data characterizing prototype system performance was collected from 171 instances of prototype execution using a total of 78 images collected from UAV and satellite platforms during the 2020 growing season. Each image served as input to the system at least twice, once imported from a remote server location and once from a local cache. Important parameters related to the speed of execution including internet download speed at the time of execution, collection platform, image source (remote or local cache), image file size, image resolution, image total pixels, and site characteristics (e.g. number of blocks, site acres) were collected. Execution of each prototype system module in FIG. 4 was timed and recorded. Data were analyzed in MatLab. To determine the expected total execution runtime for typical quarter section irrigated row crop fields, the execution time of modules dependent on site-specific, image-specific, and operations-specific variables was modeled based on the collected data for those variables during the testing. Modules modeled were image import, image filtering, and image analysis which are each dependent on some combination of number of total image pixels, combined number of indicator blocks and sub-regions in the field, and download speed. The image analysis model was poorly conditioned for a combined number of indicator blocks and field sub-regions less than 26 due to the data available.

To model the expected total execution time for typical quarter section irrigated row crop fields, a range of expected values for total indicator blocks and field sub-regions and pixels was tested in these models. Because download speed would vary significantly based on the user location, it was uniformly included in the model at a representative low value of 35 mbps instead of included as a range of values. At each one of these values, the expected execution time for image import, image filtering, and image analysis was computed and was added to the average execution time observed across all executions for all other system components combined. This produced a total expected runtime value as a function of image pixels and combined number of indicator blocks and field sub-regions. Total expected runtime values were determined for every combination of total image pixels and combined number of indicator blocks and field-sub-regions under import conditions with remote image storage. Remote storage conditions were selected as that is expected to be the dominant source of imagery for such a system implemented commercially in partnership with commercial imagery providers. The data for UAV imagery is presented in FIG. 10B and the data for satellite imagery is presented in FIG. 10C. Based on this data, for a typical quarter section that has 30 combined indicator blocks and field sub-regions with UAV imagery collected averaging 9.2×10⁷ total pixels per image, the system is expected to execute the entire process from user login to prescription generation and export in 7.4 minutes. The parameters chosen for this typical quarter section represent the average values for combined indicator blocks and field sub-regions and total image pixels in experimental trials conducted during the 2020 growing season. Alternatively, for the same quarter section with satellite imagery collected averaging 6.2×10⁴ total pixels per image, the system is expected to execute the entire process in 3 minutes. Both of these execution times demonstrate significant reductions in total time expenditure versus manual execution of this process. Additional execution time reduction could be achieved with higher download speeds, though that may not be achievable in rural areas in which this system may be implemented. Further reductions in execution time could also be achieved if the user chose to use default settings rather than user input in several modules, completely closing the automation loop.

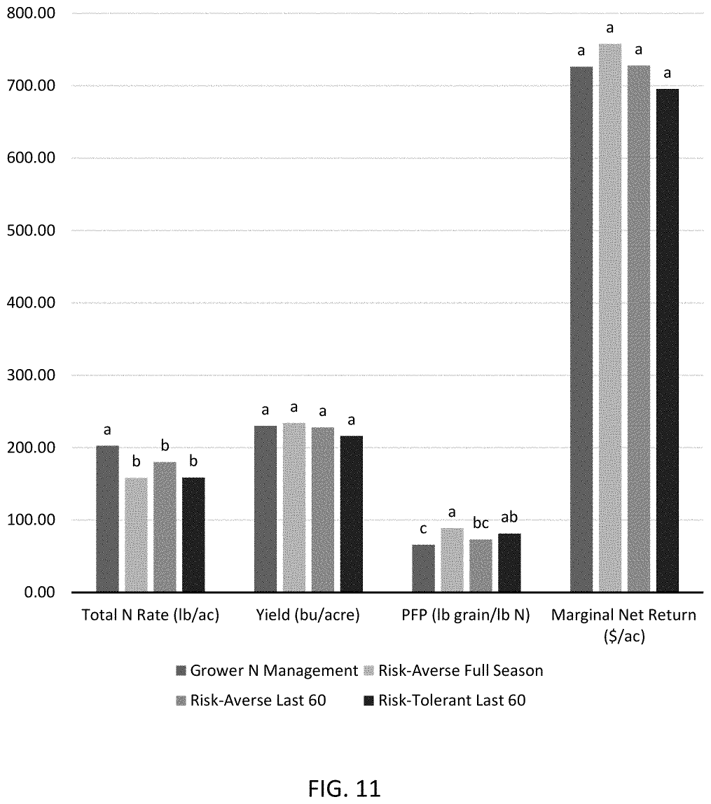

Aggregate results from sensor-based fertigation management trials during the 2019 and 2020 growing season depicted in FIG. 11 demonstrate that there were no statistically significant differences in yield between average grower management and sensor-based fertigation management approaches. All sensor-based fertigation management treatments applied less total N than the average grower by a minimum of 22 lb N/ac. Corresponding to these low applied N rates, all sensor-based fertigation management treatments demonstrated numerically higher nitrogen use efficiency than the average grower. NUE is often measured using the partial factor of productivity (PFP), which is defined as the ratio of crop yield (bu/ac) to total amount of N applied (lb N/ac). The PFP was statistically significantly higher than the average grower for both the risk-averse full-season treatment and the risk-tolerant last 60 treatment. This is an important metric because it suggests that the sensor-based fertigation treatments applied less excess nitrogen than the average grower, ultimately resulting in reduced environmental impact. There were no statistically significant differences in marginal net return between any of the treatments. Despite the increases in efficiency associated with the sensor-based fertigation treatments, there was no discernable difference in the profits from these treatments and the profits from the average grower. Numerically, the risk-averse full-season treatment had the highest net return of $757.94/ac while the risk-tolerant last 60 treatment had the lowest net return of $695.54/ac. It is important to reiterate that the sensor-based full-season treatment and the risk-tolerant last 60 treatment both only have one year of data included in the dataset. Therefore, data for the average grower and the risk-averse last 60 treatments are most reliable due to having two complete growing seasons' worth of data. Additionally, data from one site that did not include a grower management treatment are included in the aggregate dataset since sensor-based fertigation management treatments followed the same protocol as at all other sites. Because those treatments cannot be compared versus typical grower management at that site, however, they are not included in the site-by-site evaluation dataset. All data from the site with testing problems alluded to above was retained in the presented aggregate data for brevity because inclusion of this data does not cause significant changes in trends on the aggregate level. However, as will be demonstrated subsequently, inclusion of all data from this site does affect trends in the data when evaluated site-by-site.

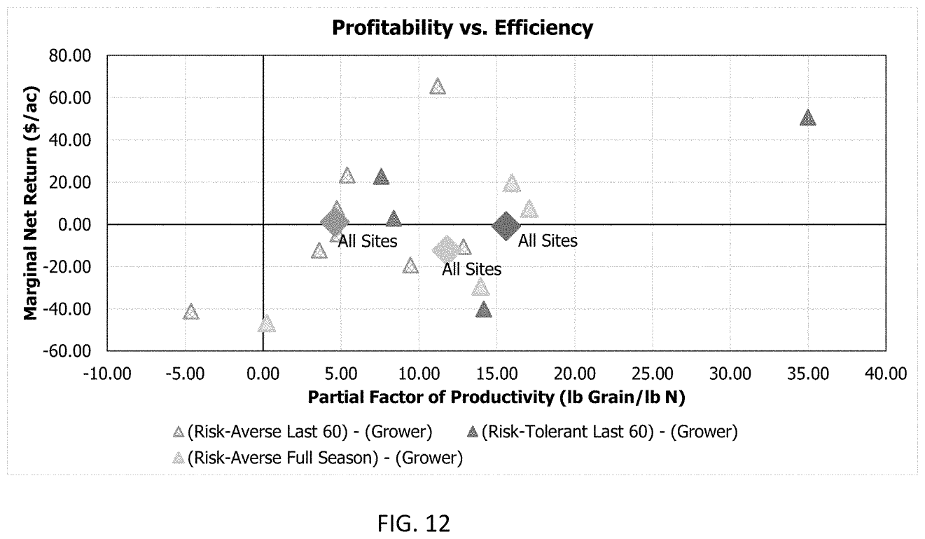

Comparing treatment performance on a site-by-site basis is a more rigorous approach to evaluating the data as it compares each treatment's performance to the grower's standard practice at each site. All growers who cooperated in these research trials practice multiple split-application fertigation management and other best management practices and therefore already operate with high nitrogen use efficiency. Due to their experience managing the fields on which the trials are conducted, each grower's standard practice is expected to produce the optimal outcome for the field. Comparison versus grower management in these conditions on a site-by-site basis is a rigorous method for evaluating sensor-based fertigation efficacy. FIG. 12 shows a scatter plot of the differences in nitrogen use efficiency (measured as PFP) and marginal net return between the sensor-based fertigation management approaches and standard grower management on a site-by-site basis. Individual sites are shown with triangles and average differences across all sites are shown with diamonds. This data demonstrate that most sensor-based fertigation management approaches across all sites at which they were tested resulted in higher efficiency than typical grower management at that site. Furthermore, the data demonstrate that there is significant variability in marginal net return differences across sites. Overall, 94% of sensor-based fertigation implementations resulted in higher nitrogen use efficiency than the grower's typical management and 53% resulted in higher profit than the grower's typical management. The lone implementation in which sensor-based fertigation efficiency was lower than typical grower management occurred in 2019. In this implementation, the first sensor-based fertigation application of the year occurred 28 days after the indicator block establishing application. This application was later than it should have been due to insufficient labor for manual data processing and a lack of an available automated solutions, such as the prototype system described herein. Analysis of imagery collected during that 28-day interval revealed that an application should have been made 12 days earlier when indicator blocks first showed signs of deficiency at the V7 growth stage. On average, the bulk crop area for both sensor-based treatments showed N deficiency with SIs below SI_{std} before a fertigation application was made, which potentially resulted in reduced yield and therefore poor efficiency and profit performance for this implementation. While it is impossible to claim with certainty that an earlier application would have positively affected the yield outcome, it has been demonstrated that significant early season deficiencies (SI ≤0.90) as late as the V8 growth stage cannot be corrected in order to maximize yield potential (Varvel et al., 1997).

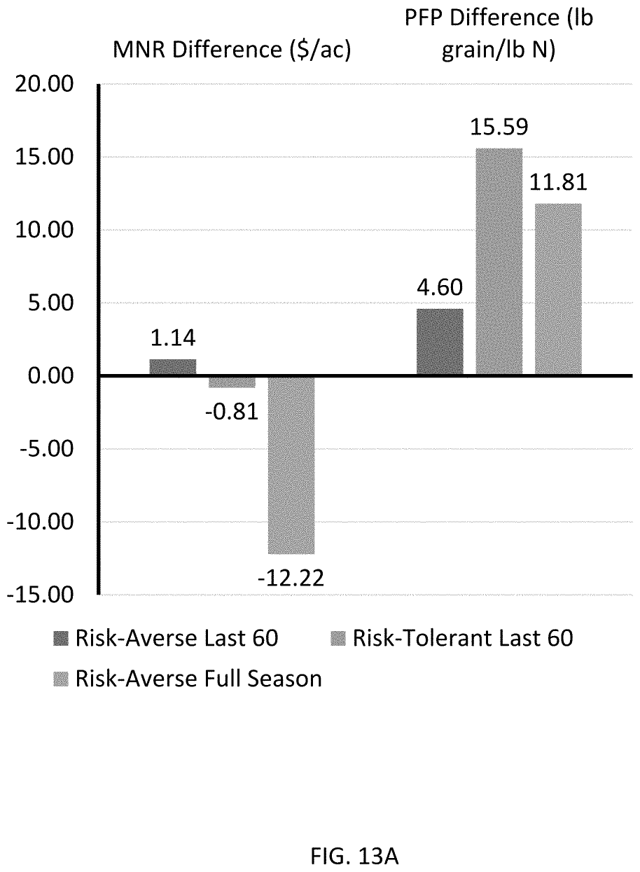

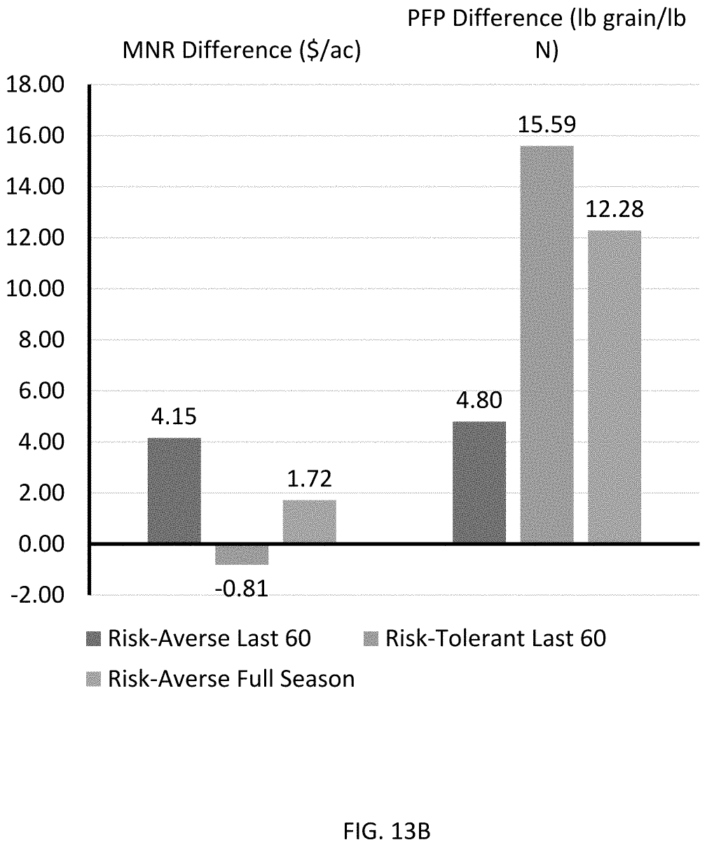

Average differences between sensor-based fertigation management approaches and typical grower management across all sites are shown in FIGS. 13A and 13B. On average, the risk-averse approach implemented for the last 60 pounds of applied N resulted in an efficiency increase of 4.6 lb grain per lb of N and a marginal net return increase of $1.14/ac versus typical grower management. Conversely, the risk-averse approach implemented for the full growing season resulted in a $12.22/ac profit decrease versus typical grower management, though it did result in an increase in efficiency of 11.81 lb grain per pound of nitrogen. The risk-tolerant approach implemented for the last 60 lb of applied N lost less than $1/ac versus typical grower management while simultaneously increasing efficiency by 15.59 lb grain per lb N. It is important to note there is one replication out of four experimental replications at a single site included in the dataset in which sensor-based fertigation treatments were likely disproportionately impacted by wind damage and extraordinary weed pressure. If that single replication is removed from the dataset, the trends in the data change drastically as shown in FIG. 13B. With that change, the risk-averse approach implemented for the last 60 lb of applied N averaged a profit increase of $4.15/ac versus typical grower management. Additionally, the risk-averse approach implemented for the full season resulted in an average profit increase of $1.72/ac versus typical grower management and the efficiency increase associated with the approach implementation was 12.28 lb grain per pound of nitrogen. With the removal of that single rep, the proportion of sensor-based fertigation treatment implementations which led to profit increases versus typical grower management rose to 65%. To reiterate, both the risk-averse approach implemented for the full season and the risk-tolerant approach implemented for the last 60 lb applied N only have one year of data included in the dataset. In conclusion, it is apparent from field trials conducted on commercial scale corn fields following commercial scale production practices that sensor-based fertigation consistently results in higher nitrogen use efficiency than typical grower management and has significant potential to increase profit versus typical grower management. UAV images were primarily used in the experiments, but other remote imaging sources can be used. Planet Labs, a multispectral satellite imagery provider, is beginning to launch satellites offering the RE band at 3 m/pixel resolution which will open the door for implementation of this method using satellite imagery. These images can be used as remote multispectral image input for the system.

Additional Details of Preferred Embodiments and Experimental Prototypes

The prototype discussed above interfaced with commercially available agricultural control systems, and outputted export converted data according to module 414 in FIG. 4.

A commercially available ecosystem from AgSense® was used, which includes CropLink®, FieldCommander® modules and the WagNet mobile app interface. The automated prototype software consistent with FIGS. 4 and 7 generates an output that is formatted for compatibility with the AgSense fertigation control ecosystem. CropLink® and FieldCommander® work conjunctively in-field and communicate with an online server via cellular networks to control fertigation applications based on pivot position. The WagNet mobile interface enables remote control of those devices via the same cellular networks. One feature that is advantageous for fertigation control is that the WagNet mobile system enables degree-based rate prescriptions that can be uploaded as a formatted CSV. The prototype software of FIG. 4 outputs from module 414 properly formatted CSV files for upload to the WagNet system corresponding to the prescription generated based on the analytics output and fertigation decisions of modules 410 and 412. The module 412 provides a foundation for API integration with the WagNet system or other systems to for complete automated fertigation control.

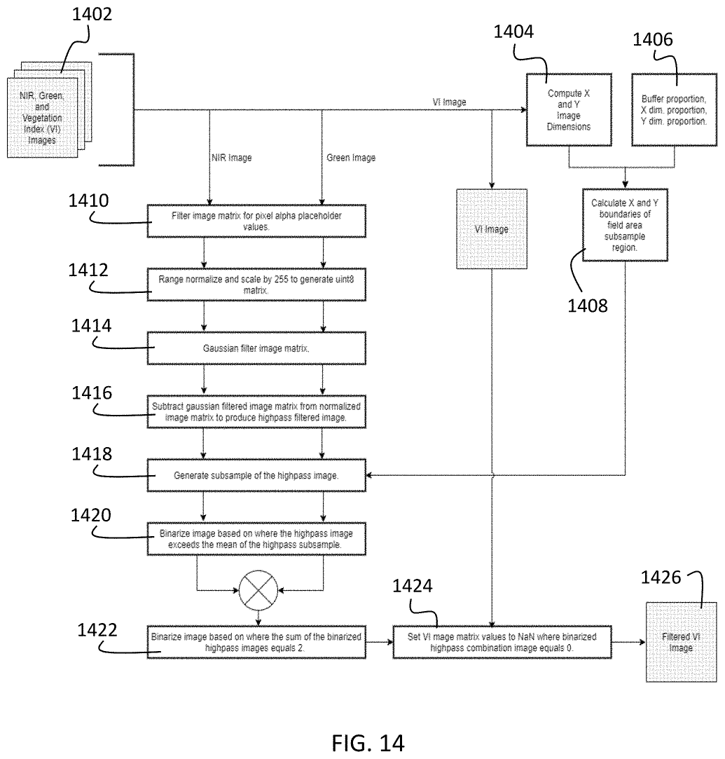

With regard to the modules in FIG. 4, a preferred module for image preprocessing 406 is illustrated by the flowchart of FIG. 14, which is referred to as “removesoil”. This module uses NIR, Green, and vegetation indexed images as an input image 1402. The function can also take as input a single raster containing multiple bands including the NIR, Green, and Red-Edge or Red band, and then conduct thresholding 1404 to separate the data bands. Once the separate images or single raster has been input, the x and y image dimension sizes are computed 1404 using the VI (vegetation) image. Those sizes are then used in conjunction with three static parameters in 1406—buffer proportion, x-dimension proportion, and y-dimension proportion—to determine the x and y dimension boundaries 1408 of a predominantly crop area subsample region of the image. The buffer proportion parameter is equal to the decimal expression of the percentage of x and y dimension size that equals half of the x and y dimension size for the generated subsample region. In an example version, the buffer proportion is 0.05 indicating that the size of the subsample x and y dimensions should be 10% of their respective dimension sizes in the original image. Similarly, the x-dimension proportion and y-dimension proportion set the proportion of the total dimension size in the original VI image at which the center of the subsample region is located. An example x-dimension proportion is 0.5 and the y-dimension proportion is 0.4. For a square image with 10,000-by 10,000-pixel resolution, this would mean that the center of the subsample region would be located at the 5000-pixel position in the x-dimension and 4000-pixel position in the y-dimension. These values were chosen deliberately to minimize the possibility of directly locating the subsample region over any areas with significant feature removal, such as the pivot center location. Using all three parameters, the algorithm calculates the x and y boundaries of the crop area subsample region.

Once these calculations are complete, the algorithm processes the NIR and Green band images identically. First, images are filtered 1410 then normalized and scaled 1412 to generate an unsigned 8-bit integer image matrix. The images are then Gaussian filtered 1414 to produce lowpass filtered images. The lowpass filtered images are then subtracted 1416 from their respective original image to produce highpass filtered images. Next, the highpass images are subsampled 1418 within the subsample boundaries computed in step 1408. The highpass images are then binarized 1420 based on where the images' pixel values exceed the respective means of the highpass subsampled images. Resulting binarized images are then summed, and the result is binarized 1422 based on where the summed image pixel values are equivalent to 2. This final binarized image is then used as a mask to retain all original VI image pixel values where binarized image pixel values are 1 and set 1424 all other VI image pixel values to NaN (not a number). A filtered VI image is the fmal algorithm output 1426.

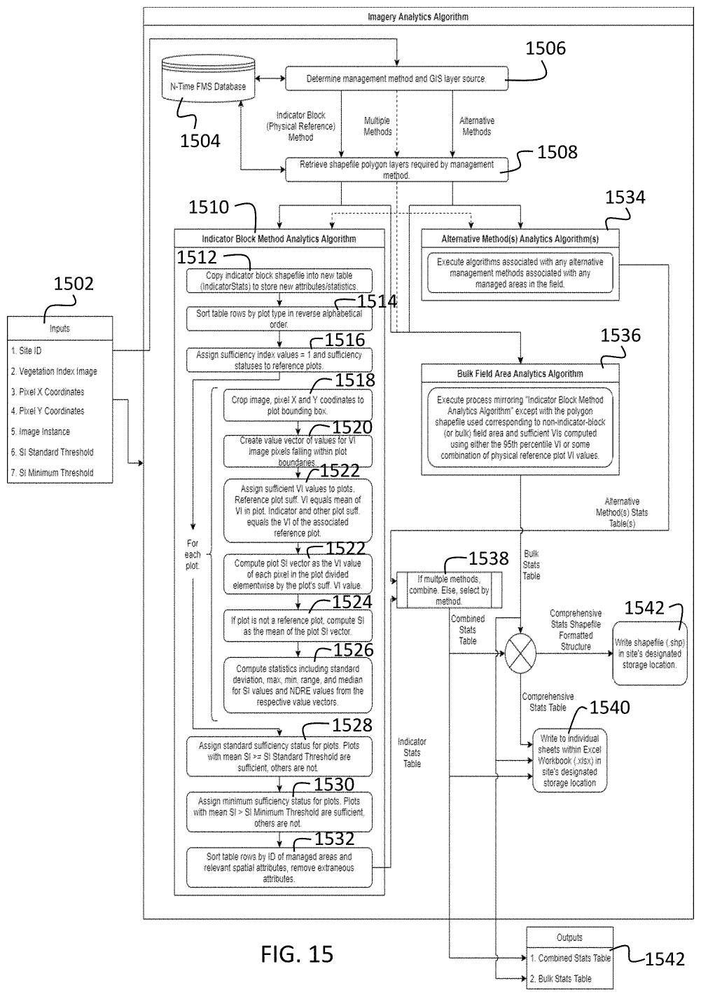

A preferred flowchart for the module of image analysis 408 is shown in FIG. 15. The preferred module 408 takes 7 input values 1502: Site ID, VI image, pixel x-coordinate matrix, pixel y-coordinate matrix, image instance, SI standard threshold, and SI minimum threshold. SI standard threshold and SI minimum threshold may be specified by the user or selected as default values. The module 408 queries an N-Time FMS database 1504 to determine the management method(s) 1506 for the site based on the site ID and subsequently retrieves the appropriate (user selected) shapefile polygon geospatial layers 1508 required for algorithm execution depending on the management method designation, i.e., multiple or CR (canary-reference paired plot). Other methods can be mixed in and used for certain field sub-regions (sectors) and CR used for the remaining field sub-regions (sectors). Depending on the management method designation, the algorithm then executes one or more sub-algorithms, always including a bulk field area analytics algorithm 1510. The sub-algorithm executing the present fertigation decision method is the Indicator Block Method Analytics algorithm 1512, which computes statistics for all plots in each indicator block in all managed area(s). A geospatially referenced statistics table is generated 1512 by copying the geospatial layer information. This table sorts 1514 the table to bring reference plots to the top of the stack (e.g. reverse alphabetical order if “reference” is last in the data set), and assigns 1516 sufficiency index values of 1 and sufficiency statuses of “Yes” to all reference plots. For each row in the table (corresponding to each plot in the field) it then crops 1518 the input VI image to the plot bounding box, creates a VI value vector 1520 consisting of only values of pixels that fall within the specific polygon boundaries, assigns sufficient VI values 1522 to each plot, computes the plot SI vector 1524. The sufficient VI for a reference plot is equal to the mean of the VI values in the plot. The sufficient VI for all other plots is equal to the sufficient VI of the reference plot. This is the computer implementation of Eq 2 where the sufficient VI is the mean VI of the reference plot. A next step, when the plot being considered is not a reference plot, the method computes the mean 1526. Other statistics, including standard deviation, max, min, range, and medians for SI values, and VI values from the respective value vectors as necessary for both the SI and VI.

After these processes are completed for each plot, standard sufficiency statuses 1528 and minimum sufficiency statuses 1530 are assigned to each plot by comparison of the mean plot SI with the SI standard and minimum threshold values. The table is then sorted 1532 by ID of managed area and other spatial attributes and published in the script as the indicator stats table.

Alternative method algorithms 1534 can also be plugged into the algorithm and executed to produce alternative method stats tables for purposes of comparison or reasonable prescription testing. In step 1534 alternative fertigation methods can be used for some sectors/sub-regions. Once the indicator block method or other analytics method algorithm(s) are executed, the bulk field area algorithm 1536 is executed, performing the indicator block method algorithm to produce the bulk stats table. This table includes identifying information for the sub-regions/sectors, percent area representation of parent field sub-region/sector, actual area in acres, type of region, statistics for SI values, statistics for VI values, sufficiency statuses. If multiple methods are used, the indicator and alternative stats tables are combined 1538; otherwise, the table for the single method used is selected. The resultant combined stats table is appended to the bulk stats table to produce the comprehensive stats table. The comprehensive stats table, combined stats table, and bulk stats table are written 1540 to unique sheets in an Excel workbook (.xlsx). Additionally, the comprehensive stats table is reformatted 1542 to include required shapefile attributes (“Geometry,” “Bounding Box,” “X” or “Lon,” and “Y” or “Lat”, appended to the table to provide geospatial definition) and written to a shapefile in ESRI (Environmental Systems Research Institute) format saved in the specific site's designated storage location. The combined and bulk stats tables are then outputted 1542.

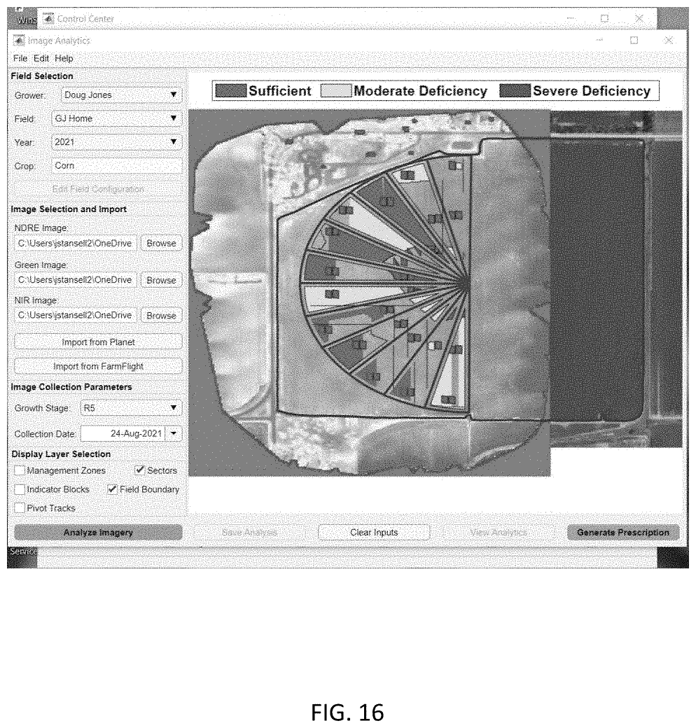

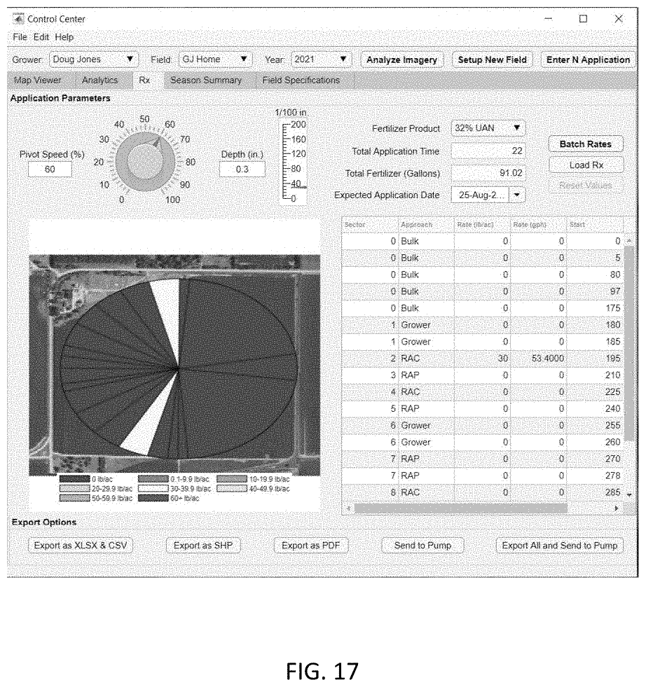

FIGS. 16 and 17 show example system interface screens. FIG. 16 shows a displayed result of the image analysis steps 408 and 410 of FIG. 4 and FIGS. 14 and 15. The display of FIG. 16 includes areas of sufficient fertigation, moderate deficiency and severe deficiency. FIG. 17 show an example prescription display, with the prescription having been determined by the system of the invention and providing options to sent to a fertigation pump or various other output options.

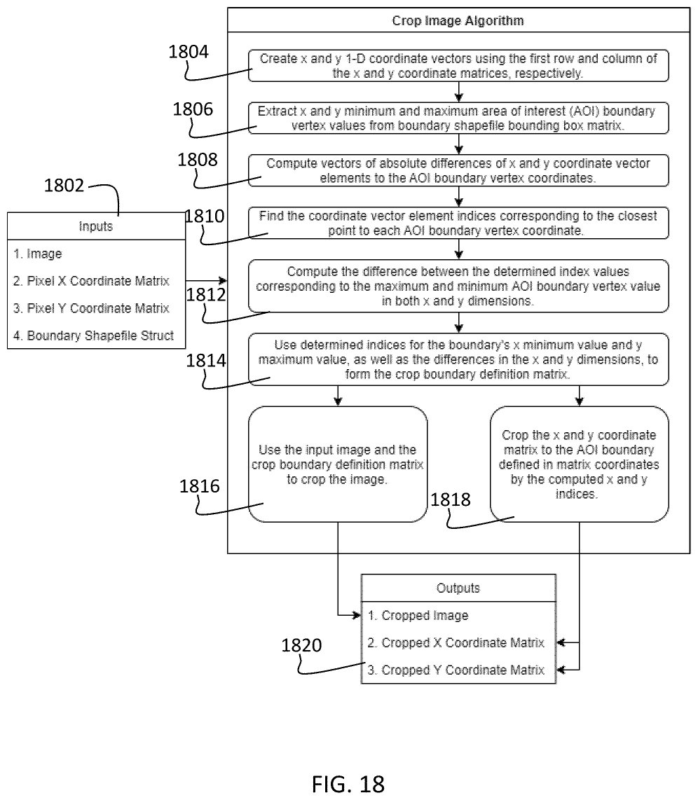

FIG. 18 shows the logic of a preferred helper module to speed the image analytics module (module 408 in FIG. 4). Selecting pixels that fall within plot boundaries from all pixels within a high-resolution image is a time-consuming operation that can significantly hinder the analytics algorithms efficiency. The FIG. 18 module can crop images and pixel coordinate matrices to area-of-interest (AO′) bounding boxes to limit the processing extent of pixel in boundary identification. The module takes an image, the pixel x-coordinate matrix, the pixel y-coordinate matrix, and the boundary shapefile data structure 1802 as inputs. It summarizes the x- and y-coordinate matrices to 1-D coordinate vectors 1804 using the first row and column of the x- and y-coordinate matrices respectively. After determining the x and y maximum and minimum values for the AOI boundary 1806 from the AOI bounding box matrix, it computes the difference 1808 of all x- and y-coordinate values from each respective dimension's minimum and maximum values. The vector element indices of the closes x- and y-coordinate values are then identified 1810 and used to set the image pixel index boundaries 1812 for the crop boundary definition matrix. Additionally, the absolute difference between the maximum and minimum index value in each dimension is used 1814 to determine the size of the rectangular crop boundary in each dimension. Finally, the algorithm crops the image to the crop boundary 1816 and additionally crops the x- and y-coordinate matrices 1818 using the minimum and maximum index values. Outputs of the module 1820 are the cropped image and cropped x- and y-coordinate matrices.

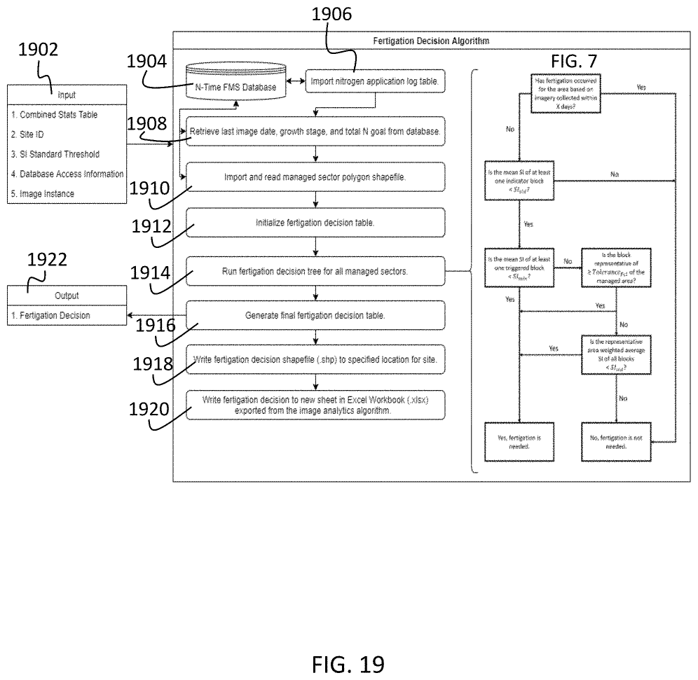

FIG. 19 is another module that can be used for fertigation decision of module 410 of FIG. 4. The fertigation decision module takes the combined stats table, site ID, SI standard threshold, database access information, and image instance as inputs 1902. Using those inputs, it retrieves critical data files, from the FMS database 1904, i.e.g., N application log table 1906 of previous applications, site specific data of last image, growth state and total N application 1908 and the polygon shapefile 1910. Next, it initializes a fertigation decision table 1912 then populates that table by applying the fertigation decision tree 1914 (per the FIG. 7 decision logic) to plots within each managed sector in the field. After that process is completed, the final fertigation decision table is generated 1916 and written to a shapefile 1918 in the specified storage location for the site as well as appended as a unique sheet 1920 to the Excel workbook written initially by the analytics algorithm. The output 1922 of the fertigation decision algorithm is the final fertigation decision table.

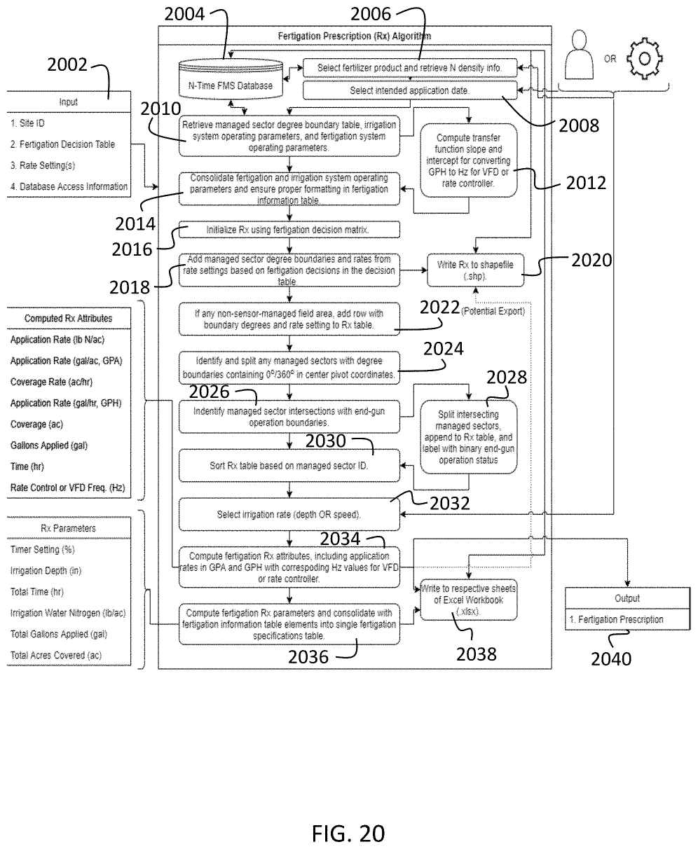

FIG. 20 shows logic for a preferred prescription generation module 412 of FIG. 4. The fertigation prescription (Rx) algorithm takes site ID, fertigation decision table, rate settings, and database access information as inputs 2002. Employing those inputs, the algorithm retrieves product information from the N-Time FMS database 2004. The algorithm user or the automated system (depending on operating preference) selects the fertilizer product 2006 that will be used in the fertigation application. Next, the user or system selects 2008 the intended application date. Once these pieces of information are established, the algorithm retrieves 2010 sector degree boundary information, irrigation system operating parameters, and fertigation system operating parameters. Intercept and slope for the transfer function from injection rate (gal/hr) to operation frequency (Hz) of the rate controller output or variable frequency drive (VFD) in the pump system are computed 2012. Fertigation and irrigation system operating parameters are then consolidated 2014 into a single table. Once this process is completed, the Rx is initialized 2016 using the fertigation decision matrix and managed sector degree boundaries and rates based on fertigation decisions in the table and site rate settings are appended 2018 as attributes to the table. This version of the Rx table is validated for appropriate formatting and written to a shapefile 1920 in the site's specified storage location. For research purposes, if any non-sensor-managed field area exists—based on degrees between 0 and 360 not encompassed by boundaries of managed sectors—a row for the area is appended to the table 2022 bounded by the non-sensor-managed degrees. If any managed sector is identified as intersecting 2026 the 0°/360° angle in pivot coordinates, the algorithm splits 2028 that managed sector. This is an important step in formatting prescriptions for commercial applications that require one start degree at 0° one stop degree at 360°. Specifically, using end-gun operation parameters defined in the consolidated fertigation and irrigation system operating parameters table, the algorithm identifies 2026 managed sector intersections 2026 with changes in end-gun operation status and splits 2028 intersecting managed sectors, adding necessary rows to the Rx table. Upon completion, the Rx table is sorted 2030 based on sector ID. The user or system then selects the desired irrigation rate 2032 by either depth or speed and using those values the algorithm computes specific application attributes and adds them to the table. Additionally, fertigation Rx parameters are computed 2034 and appended 2036 to the consolidated fertigation and irrigation operating information table to create a fertigation application specification table. Both the Rx table and fertigation application specification table are written 2038 to unique sheets in a single Excel workbook. The final Rx table can also be written to a shapefile. The output 2040 of the module is the final fertigation Rx table.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A fertigation system, comprising:
a graphical user interface (GUI) to a controller for a field irrigation system and fertilizer injection pump, the GUI providing a user with menus to initiate an automated fertigation process;
an input to the controller configured to receive multispectral image data of a crop in the field;
software to preprocess the image data to remove non-vegetative features from the image data;
software to determine crop N status from a vegetation index calculated from the image data of indicator blocks having at least two plots, one with a reduced N application rate (canary) and one with an increased N application rate (reference) versus a bulk area N application rate; and
software to determine a fertigation decision based upon the N status and configure instructions for the controller to direct the field irrigation system and the fertilizer injection pump to provide fertigation based upon the fertigation prescription.

2. The system of claim 1, comprising an image source to provide image data on daily, weekly or biweekly basis, wherein the software to determine N status, software to determine a fertigation decision, and software to configure a fertigation prescription determines a new fertigation decision and creates a new fertigation prescription with each updated image data.

3. The system of claim 2, wherein the software to determine a fertigation decision immediately following receiving updated image data determines:
$${SI}_{plot} = \frac{1}{n} {\sum }_{i = 1}^{n} \frac{{VI}_{plot , i}}{{\overline{VI}}_{reference}} ”$$
where VI is a vegetation index for plots and n is the number of plots.

4. The system of claim 2, wherein the image data is crop canopy reflectance data for the crop in the field.

5. The system of claim 5, wherein the image data is provided from an unmanned arial vehicle.

6. The system of claim 5, wherein the image data is provided from satellite imagery.

7. The system of claim 2, wherein the image source provides image data during a growing season for the field in the crop.

8. The system of claim 1, wherein the image data comprises geospatial data.

9. The system of claim 1, wherein the image data is crop canopy reflectance data for the crop in the field.

10. The system of claim 1, wherein the software to determine the fertigation decision determines that fertigation should occur for a sub-region in the field when there has not been a fertigation for that sub-region, when a mean sufficiency index for the sub-region is less than a standard sufficiency index, and when the mean sufficiency index of the sub-region is less than a minimum.

11. The system of claim 1, wherein the software to preprocess processes NIR and green data in the image data and determines highpass filtered data of the NIR and green data, samples the values in the highpass filtered data that exceed a mean of values in the highpass filtered data, and uses sample values as a mask to select crop regions.

12. The system of claim 1, wherein the software to determine crop N status by determining a sufficiency index (SI) of each plot in a field sub-region, assigns an SI block value for each indicator block based on the SI plot values, and determines the sufficiency status for each indicator block and thereby the proportion of the field sub-region.

13. The system of claim 1, wherein the software to preprocess clips the input data to a bounding box of each geospatial sub-region for which image analytics are applied.

14. The system of claim 1, wherein the software to determine crop N status executes a fertigation decision tree for a field sub-region having at least two plots based upon VI sufficiency of the sub-region.

15. The system of claim 1, wherein the software to determine the fertigation decision retrieves fertigation pump and/or irrigation system parameters, gathers preferred application settings, and produces target fertigation pump injection rates according to the system parameters and application settings.

16. The system of claim 1, wherein the at least two plots are adjacent plots created by an initial fertigation application to define the canary plot having an N deficit and the reference plot having an N surplus.

17. A fertigation system, comprising:
an input to receive crop canopy reflectance data of a field from an above crop image source;
a module to analyze the crop canopy reflectance data and determine a fertigation decision for each of a plurality of plots in the field, wherein the crop reflectance data is analyzed to determine:
a. Indicator blocks that are comprised of two or more of the plots in the field, with at least one plot being established with a reduced N application rate (canary) and one plot being established with an increased N application rate (reference) versus a bulk field area in which they are embedded, established adjacently to each other in the field through a N fertilizer application;
b. A vegetation index generated from computational transformation of crop canopy reflectance data that is used to quantify biomass amount, crop performance, photosynthetic rates, or another similar crop health metric;
c. N sufficiency status for each plot in the field is quantified using a sufficiency index as:
i.
$${SI}_{plot} = \frac{1}{n} {\sum }_{i = 1}^{n} \frac{{VI}_{plot , i}}{{\overline{VI}}_{reference}} ,$$
where SIₚₗₒₜ is equivalent to SI_{block} when the plot is a canary;
d. a fertigation decision is determined for each of the plurality of plots that has a sufficiency index that fails to meet a predetermined relationship to the N sufficiency status; and
a module to output the fertigation systems to control a field irrigation system and fertilizer injection pump.

18. Software for a fertigation system, comprising
a module configured to receive or retrieve crop canopy reflectance data for a crop in the field;
a module to preprocess the crop canopy reflectance data to remove non-vegetative features from the imagery data and to determine a plurality of plots in the field from the data;
a module to determine crop N status from the image data of indicator blocks having at least two of the plurality of plots, one with a reduced N application rate (canary) and one with an increased N application rate (reference) versus a bulk field area N application rate, at determined sampling locations within field area; and
a module to determine fertigation decisions for the plurality of plots and determine a prescription for the plurality of plots based upon the N status and configure instructions for a fertigation controller direct a field irrigation system and a fertilizer injection pump to provide fertigation based upon the fertigation prescription.

19. A method for controlling an automated fertigation system, the method comprising:
defining sub-regions in a field being managed;
in each sub-region, applying N (nitrogen) to create adjacent canary and reference plots, wherein a canary plot is given less than a designated N amount and a reference plot;
subsequently imaging the sub-regions, and for each sub-region generating a fertigation decision based upon automatic analysis of the vegetation indices of the canary and reference plots in each sub-region.
